(19) United States
(12) Patent Application Publication
(10) Pub. No.: US 2026/0093168 A1
(43) Pub. Date: Apr. 2, 2026

(54) IMAGE PROJECTOR, AND METHOD FOR CONTROLLING SAME

(71) Applicant: LG ELECTRONICS INC., Seoul (KR)

(72) Inventors: Chala PARK, Seoul (KR); Youngran KIM, Seoul (KR); Jaesun YUN, Seoul (KR); Jina KIM, Seoul (KR)

(73) Assignee: LG ELECTRONICS INC., Seoul (KR)

(21) Appl. No.: 19/109,015

(22) PCT Filed: Sep. 6, 2022
(86) PCT No.: PCT/KR2022/013362

§ 371 Date: Mar. 5, 2025

(51) Int. Cl. G03B 21/14; F16M 11/10; G03B 21/20; G03B 29/00; G06F 3/16; H04N 9/31

(52) U.S. Cl. CPC G03B 21/145; F16M 11/10; G03B 21/2046; G03B 29/00; G06F 3/167; H04N 9/3185; H04N 9/3194

(57) ABSTRACT

An image projection device can include an input unit including a camera which obtains ambient image information and a microphone which collects ambient sound signals including voices, a sensing unit including an illuminance sensor which detects ambient illuminance, an output unit including an image output unit which outputs the image information and a light source unit which emits light, a drive unit capable of changing the horizontal direction and vertical direction the output unit is facing, as well as the height of the output unit, and a control unit which determines whether an image projection request is made on the basis of the information sensed through the input unit, and which controls the drive unit and the output unit.

### TECHNICAL FIELD

The present disclosure relates to a device (projector) that projects image information.

### BACKGROUND ART

An image projection device, that is, a projector, which is a device that projects light including image information on a designated region, may display the image information in an enlarged manner. Accordingly, the image information may be enlarged and played on a large screen without limitations according to a size of a display device, and thus there is an advantage of allowing multiple users to view image information together or transmitting more realistic image information to a user through a large screen.

However, the image projection device is conventionally formed to project light including image information on a fixed screen region. Accordingly, the quality of the projected image may be determined based on many factors, such as a distance between a light source unit that emits light including image information and the screen region, and the locations of the light source unit and the screen region. Therefore, conventionally, it is common for the image projection device to be installed at a fixed location to have a fixed setting value so as to allow an image to be output with an image size or image clarity desired by the user.

Accordingly, the image projection device is installed to face a fixed screen region according to such a fixed setting value, so in order for the image projection device to project image information on a different screen region, there is a difficulty in that the user must directly change a direction faced by the light source unit of the image projection device, and the setting value must also be modified according to the changed screen region.

Moreover, nowadays, with the development of technology, as the image projection device provides an image with clearer image quality, the image projection device is increasingly being used for home use. In addition, as the image projection device is used for home use, instead of a screen, a method of utilizing a wall surface region at the user's home as the screen has emerged, and as a result, image information can be provided through the image projection device without a screen.

Meanwhile, as a wall at home is freely utilized as a screen in this manner, social needs to use various wall surfaces at home as a screen have emerged. As part of such social needs, there has been a demand from customers to project high-quality image information on a specific wall surface at home desired by the user without the user having to directly change a direction or setting value faced by the light source unit of the image projection device, and methods to address the demand are currently being actively researched.

In addition, the image projection device may project an image including information to transmit information needed by the user through the image. Therefore, by using the characteristics of the image projection device, research is actively being conducted on methods to utilize the image projection device in a more diverse manner by freely changing light or an image being projected or a location where the light or image is projected based on the user's request, the user's context detected, or a sensed state.

### DISCLOSURE OF INVENTION

### Technical Problem

The present disclosure aims to solve the foregoing problems and other problems, and an aspect of the present disclosure is to provide an image projection device capable of projecting high-definition image information on a specific wall surface at home desired by a user without directly changing a direction or setting value faced by a light source unit, and a method of controlling the image projection device.

In addition, the present disclosure aims to provide an image projection device capable of projecting light or an image appropriate for the user's request, the user's context, or sensed information, and projecting the light or image at an appropriate location based on the user's request, the user's context detected, or sensed state, and a method of controlling the image projection device.

### Solution to Problem

In order to achieve the foregoing and other objectives, according to an aspect of the present disclosure, an image projection device according to an embodiment of the present disclosure may include a head having an image output unit that outputs image information and a light source unit that emits light, a support whose one end is formed to connect to the head, and support the head, and a main body unit connected to the other end of the support, formed to support the support and the head connected to the support, and formed to be horizontally rotatable around a central axis, wherein a head body forming a housing of the head is formed with a head fastening groove on a side surface thereof so as to be coupled to a first protruding portion protruding from one point on the side surface at one end of the support, and the first protruding portion is coupled to the head fastening groove, and the head is formed to be rotatable up and down with respect to the support around the head fastening groove connected to the first protruding portion.

In one embodiment, the device may further include at least one satellite speaker formed to be detachable from the main body unit, wherein an upper end portion of a body of the main body unit forming a housing of the main body unit includes a storage region in which the at least one satellite speaker can be stored.

In one embodiment, the storage region may include a charging pad capable of charging at least one satellite speaker stored in the storage region.

In one embodiment, the body of the main body unit forming the housing of the main body unit may be formed with a support fastening groove extending along an up-down direction of the body of the main body unit on a side surface thereof, and a second protruding portion protruding from one point on the side surface at the other end of the support is coupled to the support fastening groove, and the support connected to the head along the support fastening groove is formed to be movable along an up-down direction of the body of the main body unit.

In one embodiment, an inner side of the head body may include at least one motor or actuator connected to a first protruding portion at one end of the support coupled through the head fastening groove to provide power for rotating the head up and down, and an inner side of the body of the main body unit may include at least one motor or actuator connected to a second protruding portion at the other end of the support coupled through the support fastening groove to provide power for moving the support up and down.

In one embodiment, the main body unit may further include a main body support portion that supports the main body unit to maintain the center of gravity of the image projection device during the rotation of the main body unit and an up-down rotation of the head.

In one embodiment, a microphone for collecting an acoustic signal around the image projection device may be formed at one end of the support.

In addition, an image projection device according to an embodiment of the present disclosure may include an input unit including a camera that acquires ambient image information and a microphone that collects an ambient acoustic signal including a user's voice, a sensing unit including an illumination sensor that detects an ambient illuminance, an output unit including an image output unit that outputs the image information and a light source unit that emits light, a drive unit that can change horizontal and vertical directions faced by the output unit and a height of the output unit, and a control unit that determines whether an image projection request is made based on information items sensed through the input unit, controls, when a specific indoor region is designated as an image projection region from a user according to a result of the determination, the drive unit to allow the output unit to face the designated image projection region, detects, when the output unit faces the image projection region, an illuminance of the image projection region, determines a size of an image to be projected according to the detected illuminance, and controls the output unit to project an image according to the determined image size.

In one embodiment, the device may further include a plurality of satellite speakers formed to be separable from the image projection device, wherein the control unit sets a specific indoor region as the image projection region according to a location where the satellite speakers are disposed, and controls the drive unit so as to allow the output unit to face the set image projection region.

In one embodiment, the control unit may determine a size of the image to be projected based on a separation distance between the disposed satellite speakers.

In one embodiment, the control unit may calculate a distance between a plurality of satellite speakers, and set, when the calculated distance is above a preset minimum distance, a specific indoor region as the image projection region according to a location where the plurality of satellite speakers are disposed.

In one embodiment, the control unit may find a region where an image can be projected from among respective indoor regions around the image projection device, select regions satisfying different image conditions from each of at least one of the found regions, and control the output unit and the drive unit to output guide information for recommending at least some of the regions selected according to the different image conditions to the user, wherein the different image conditions are conditions according to a size of the image or a brightness of the image.

In one embodiment, the control unit may detect, when an obstacle is detected in a region where the image is projected, whether a location of the projected image can be moved, and control the drive unit to change a direction faced by the output unit, or control the output unit to change a size of the projected image depending on whether the location of the projected image can be moved.

In one embodiment, the control unit may determine whether a location of the projected image can be moved depending on whether there is a region around an indoor region in a region where the image is projected with a surface curvature below a preset level, and whether a size of the region with the surface curvature below the preset level is above a preset size.

In one embodiment, the control unit may calculate, when the output unit faces the image projection region according to the control of the drive unit, a first distance between the center of the image projection region and the output unit, calculate a second distance between the output unit and the user from the user's location detected based on information items sensed through the input unit, calculate an interval angle between a first virtual line segment connecting the center of the image projection region and the output unit and a second virtual line segment connecting the output unit and the user, calculate a third distance between the center of the image projection region and the user based on the first distance, the second distance, and the interval angle, and determine a size of an image to be projected on the image projection region based on the calculated third distance.

In one embodiment, the control unit may operate, as a result of determining whether an image projection request is made based on information items sensed through the input unit, when the projection of the image is not requested, in an illumination mode to control the drive unit so as to allow the output unit to face a previously designated illumination light projection location, and to control the output unit so as to project light from the light source unit to the illumination light projection location.

In one embodiment, the control unit may change the illumination light projection location over time.

In one embodiment, the control unit may detect, when operating in the illumination mode, the user's location based on at least one of image information sensed through the input unit and the location of a speaker recognized from the acoustic signal, and project an image including information according to the user's request sensed through the input unit around the detected user's location.

In one embodiment, the device may further include a communication unit that performs a communication connection with at least one peripheral device, wherein the control unit receives, when operating in the illumination mode, image information from at least one peripheral device that is in communication connection with the image projection device, and projects the image information received from the peripheral device around the location of the detected user.

In one embodiment, the control unit may project image information synchronized with screen information displayed on a display of the at least one peripheral device around the user's location.

### Advantageous Effects of Invention

The effects of an image projection device and a control method thereof according to the present disclosure are as follows.

According to at least one of embodiments of the present disclosure, the present disclosure may include a light source unit formed to be able to tilt up and down, a height-adjustable support, and a base rotation portion capable of horizontal swivel to allow vertical and horizontal directions faced by the light source unit to be freely changed, thereby having an effect of allowing the user to freely change an image projection region to a wall surface region at home in a specific direction desired by a user.

According to at least one of embodiments of the present disclosure, the present disclosure may determine a wall surface region at home in a specific direction as an image projection region based on the user's voice or gesture or a location of a satellite speaker, and automatically adjust a size of the projected image based on a surrounding environment of the determined region projection region, thereby having an effect of allowing the user to project high-definition image information on a specific wall surface at home desired by the user without the user having to change a setting value.

According to at least one of embodiments of the present disclosure, the present disclosure may change a location at which light is projected or determining image information included in the projected light based on a result of detecting a time or the user's detected location or the user's request or the user's action, thereby having an advantage in that the image projection device can be utilized for various purposes such as a moving illumination and an artificial intelligence assistant.

### BRIEF DESCRIPTION OF DRAWINGS

FIG. 1A and FIG. 1B are structural diagrams showing a structure of an image projection device according to an embodiment of the present disclosure.

FIG. 2 is a block diagram showing a structure of an image projection device according to an embodiment of the present disclosure.

FIG. 3 is a flowchart showing an operation process of determining, by an image projection device according to an embodiment of the present disclosure, an image projection region and projecting an image.

FIG. 4 is an exemplary diagram showing examples of projecting, by an image projection device according to an embodiment of the present disclosure, images in different sizes depending on an illuminance of an image projection region.

FIG. 5 is a flowchart showing an operation process of determining, by an image projection device according to an embodiment of the present disclosure, an image projection region and a size of an image to be projected based on the locations of satellite speakers.

FIG. 6 is an exemplary diagram showing examples of determining, by an image projection device according to an embodiment of the present disclosure, an image projection region and a size of an image to be projected based on the locations of satellite speakers.

FIG. 7 is a flowchart showing an operation process of determining, by an image projection device according to an embodiment of the present disclosure, a specific wall surface designated via a remote control as an image projection region.

FIG. 8 is an exemplary diagram showing an example of determining, by an image projection device according to an embodiment of the present disclosure, a specific wall surface designated via a remote control as an image projection region.

FIG. 9 is a flowchart showing an operation process of recommending, by an image projection device according to an embodiment of the present disclosure, an image projection region based on a result of finding a surrounding wall surface region.

FIG. 10 is exemplary diagrams showing examples of recommending, by an image projection device according to an embodiment of the present disclosure, an image projection region selected as a result of the finding to a user.

FIG. 11 is a flowchart showing an operation process of detecting, by an image projection device according to an embodiment of the present disclosure, an obstacle within an image projection region, and projecting an image while avoiding the detected obstacle.

FIG. 12 is an exemplary diagram showing examples of changing, by an image projection device according to an embodiment of the present disclosure, a projection location or projection size of an image depending on a detected obstacle.

FIG. 13 is an exemplary diagram showing an example of automatically determining, by an image projection device according to an embodiment of the present disclosure, a size of a projected image according to a distance between an image projection region and a user.

FIG. 14 is a flowchart showing an operation process of operating, by an image projection device according to an embodiment of the present disclosure, as an illumination in which a location at which light is projected varies depending on a time of detection.

FIGS. 15 and 16 are exemplary diagrams showing an example of using, by an image projection device according to an embodiment of the present disclosure, as an illumination according to the operation process of FIG. 14.

FIG. 17 is a flowchart showing an operation process of providing, by an image projection device according to an embodiment of the present disclosure, appropriate information based on a user's context detected from therearound.

FIG. 18 and FIG. 19 are exemplary diagrams showing examples of providing, by an image projection device according to an embodiment of the present disclosure, information requested by a user according to the user's context according to the operation process of FIG. 14.

### MODE FOR THE INVENTION

It should be noted that the technical terms used herein are merely used to describe a specific embodiment, but are not intended to limit the present disclosure. In addition, a singular expression used herein may include a plural expression unless clearly defined otherwise in the context. A suffix “module” or “part” used for elements disclosed in the following description is merely intended for easy description of the specification, and the suffix itself is not intended to have any special meaning or function.

As used herein, terms such as “comprise” or “include” should not be construed to necessarily include all elements or steps described herein, and should be construed not to include some elements or some steps thereof, or should be construed to further include additional elements or steps.

In addition, in describing technologies disclosed herein, when it is determined that a detailed description of known technologies related thereto may unnecessarily obscure the subject matter disclosed herein, the detailed description will be omitted.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. In addition, not only respective embodiments described below, but also combinations of embodiments can of course be included within the concept and technical scope of the present disclosure as modifications, equivalents or substitutes.

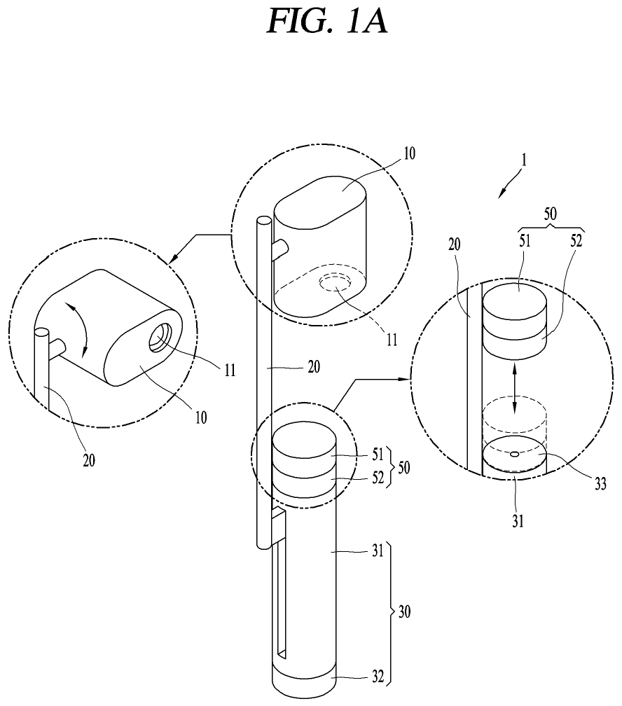

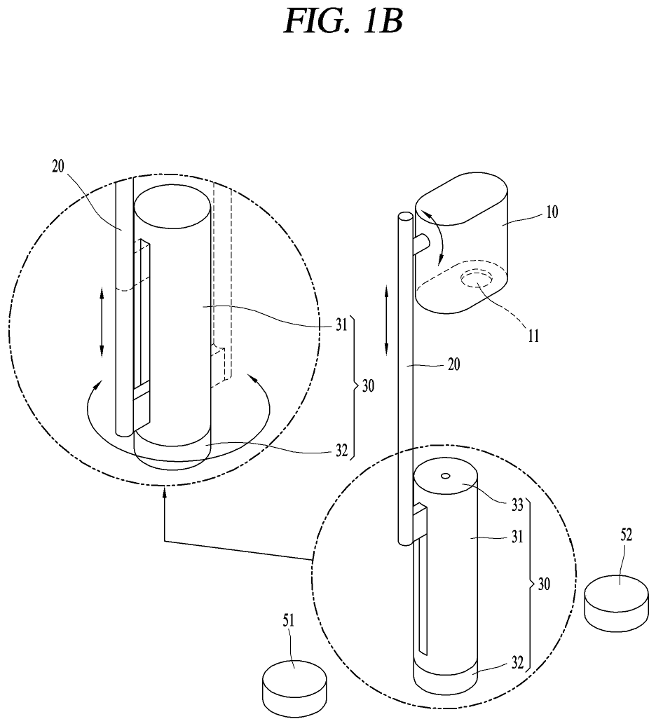

FIG. 1A and FIG. 1B are structural diagrams showing a structure of an image projection device according to an embodiment of the present disclosure.

Referring to FIGS. 1A and 1B, an image projection device 1 according to an embodiment of the present disclosure may be formed to include a head 10 having an image output unit that outputs image information and a light source unit that emits light, a support 20 whose one end is connected to the head 10, and formed to support the head 10, and a base, that is, a main body unit 30 connected to the other end of the support 20 and formed to support the support 20 and the head 10 connected to the support 20.

Here, the light source unit 252 includes at least one light source that emits light and may be embedded into a body of the head 10 that forms a housing of the head 10. The light source unit and the image output unit have one end connected to an opening region formed on a front surface of the body of the head 10, and may be connected to the other end of a light tunnel provided with a plurality of reflectors. Accordingly, light emitted from the light source unit and the image output unit is focused through the light tunnel, and the focused light may be irradiated in a direction of an open front surface of the head body connected to the light tunnel.

Meanwhile, one end of the light tunnel connected to the opening region on the front surface of the body of the head 10 may be formed with a lens unit 11 to adjust the zoom or focus of the light irradiated through the light tunnel.

Meanwhile, a fastening groove may be formed on a side surface of the body of the head 10 so as to allow coupling to a protruding portion protruding from one point on the side surface at one end of the support 20. Furthermore, a protruding portion protruding from one point on the side surface at one end of the support 20 is coupled to the fastening groove formed on the side surface of the body of the head 10, thereby allowing the side surface of the body of the head 10 and one end of the support 20 to be connected to each other. Furthermore, due to the coupling structure, the body of the head 10 may be formed to rotate at a predetermined angle in a direction perpendicular to a direction in which the fastening groove and the protruding portion of the support 20 are coupled, around the fastening groove connected to the support 20. That is, the support 20 may be formed to rotate in an up-down direction with respect to the support 20 around a direction in which the protruding portion of the support 20 and the fastening groove are coupled as an axis.

As shown in FIG. 1B, the support 20 may be supported in a direction perpendicular to the ground from the base 30. Therefore, the body of the head 10 may be coupled to rotate in a pitch direction around the support 20 as an axis. That is, the body of the head 10 may be tilted in an up-down direction around a point connected to the support 20 as an axis.

Meanwhile, an inner side of the body of the head 10 may include at least one motor or actuator connected to a protruding portion at one end of the support 20 coupled to a fastening groove on a side surface of the body of the head 10 to provide power for controlling the tilt of the body of the head 10. In this case, an angle in an up-down direction at which the body of the head 10 is tilted may be automatically changed according to the driving of the motor or actuator, and a direction in which a front portion of the body of the head 10 faces, that is, an angle in an up-down direction at which light is irradiated, may be changed according to the tilt of the body of the head 10.

Meanwhile, the image projection device 1 according to an embodiment of the present disclosure may be provided with a microphone 21 for sensing an ambient sound and a user's voice. In this case, the microphone 21 may be formed on one end portion of the support 20 supported in a direction perpendicular to the ground from the base 30 to sense sounds and voices from all directions.

Here, the microphone 21 may be formed on a front portion of the body of the head 10. However, in this case, as described above, since the front portion of the body of the head 10 can be tilted in an up-down direction, when the microphone 21 is formed on the front portion of the body of the head 10, the microphone 21 has directionality to reduce sensing efficiency in a region other than the front portion of the body of the head 10. Therefore, the microphone 21 may be more preferably formed at one end portion of the support 20.

Meanwhile, as described above, one end of the support 20 may be connected to the head 10. Furthermore, the other end of the support 20 may be connected to the base 30 that supports the support 20.

Here, the base 30 may be provided with a fastening groove formed in an up-down direction on one side surface of the body of the base 30 forming a housing of the base 30. Furthermore, on one side surface at the other end of the support 20, a protruding portion may be formed so as to be coupled to a fastening groove formed on one side surface of the body of the base 30. Accordingly, the protruding portion formed on the other end side surface of the support 20 is coupled to the fastening groove formed on one side surface of the body of the base 30, and thus the other end side surface of the support 20 and one side surface of the body of the base 30 may be connected to each other.

Meanwhile, the fastening groove formed on one side surface of the body of the base 30 may extend in a vertical direction as shown in FIG. 1B, that is, in a direction in which the body of the base 30 is erected, when the body of the base 30 is erected in a direction perpendicular to the ground. Therefore, the protruding portion formed on the other side surface of the support 20 may move along the fastening groove on one side surface of the extended body of the base 30, and accordingly, the entire support 20 may move in an up-down direction. In this case, since the head 10 is connected to one end of the support 20, the head 10 may move in an up-down direction as the support 20 moves. That is, a height of the head 10 may be changed.

Meanwhile, an inner side of the body of the base 30 may include at least one motor or actuator connected to a protruding portion on the other end side of the support 20 coupled to a fastening groove on a side surface of the body of the base 30 for controlling an up-down movement of the support 20. In this case, an up-down movement distance of the support 20 may be changed according to the driving of the motor or actuator, and a height of the head 10 connected to one end of the support 20 may be changed according to the up-down movement of the support 20.

Meanwhile, the base 30 may be formed to include a base rotation portion 31 formed to be rotatable and a base support portion 32 that supports the base rotation portion 31. In this case, as shown above in FIG. 1B, the body of the base 30 formed with the fastening groove coupled to the protruding portion formed on the other end side surface of the support 20 may be the body of the base rotation portion 31.

Furthermore, the base rotation portion 31 may be formed to be rotatable in a horizontal direction on the base support portion 32. That is, as shown in FIGS. 1A and 1B, that is, when the base 30 is erected in a direction perpendicular to the ground, the base rotation portion 31 may be formed to be rotatable in a yaw direction with a direction in which the base 30 is erected as an axis.

To this end, an inner side of the base rotation portion 31 may include at least one motor or actuator for controlling the rotation of the base rotation portion 31 around a central axis of the base support portion 32 connected to the base rotation portion 31. In this case, a rotation angle of the base rotation portion 31 may be changed according to the driving of the motor or actuator, and a direction faced by a front portion of the head 10 connected to one end of the support 20 may be rotated in a horizontal direction by a predetermined angle according to the rotation of the base rotation portion 31.

Furthermore, the base support portion 32 may have a sufficient weight to maintain the center of gravity of the image projection device 1 so as not to allow the image projection device 1 to shake even when the base rotation portion 31 rotates. That is, since the base support portion 32 has a sufficient weight, the center of gravity of the image projection device 1 may be maintained even when the base rotation portion 31 rotates or the head 10 tilts, and shaking due to the rotation and tilt may be prevented to irradiate stable image information.

Meanwhile, the image projection device 1 according to an embodiment of the present disclosure may be formed to include a plurality of satellite speakers 51, 52 that are formed to be detachable from the base 30. The satellite speakers 51, 52 may be formed to be separated from the base 30 as shown in FIG. 1B, and may be connected to the image projection device 1 via wireless communication to output acoustic information transmitted wirelessly from the image projection device 1 as an acoustic signal. In this case, the satellite speakers 51, 52 may each output different acoustic information, and accordingly, the image projection device 1 according to an embodiment of the present disclosure may implement a stereo function through the satellite speakers 51, 52.

Meanwhile, the plurality of satellite speakers 51, 52 may be formed so as to be stored in the base 30 of the image projection device 1. As an example, as shown in FIG. 1A, a storage region in which the plurality of satellite speakers 51, 52 can be stored may be provided on the upper end portion 33 of the base 30. Furthermore, the plurality of satellite speakers 51, 52 may be formed to be stacked and stored in the storage region. In this case, the storage region of the upper end portion 33 of the base 30 may be provided with a fixed portion capable of fixing the plurality of satellite speakers 51, 52 stored when the plurality of satellite speakers 51, 52 are stored. Furthermore, each of the plurality of satellite speakers 51, 52 may further include, when either one is stored and fixed to the upper end portion 33 of the base 30, a fixed portion for fixing another satellite speaker so as to allow either one of the stored and fixed satellite speakers to fix another satellite speaker.

However, the satellite speakers 51, 52 may be stacked and stored on the upper end portion 33 of the base 30 as shown above in FIG. 1A. Therefore, the satellite speakers 51, 52 may be provided with fixed portions capable of fixing different speakers to bottom and top surfaces thereof, respectively, and, as shown above in FIG. 1A, the plurality of satellite speakers 51, 52 may be stacked and stored in a storage region provided on the upper portion 33 of the base through the fixed portions.

Meanwhile, the plurality of satellite speakers 51, 52 may be formed to be detachable from the image projection device 1 as described above. In this case, the plurality of satellite speakers 51, 52 may be driven by power from a built-in battery. Furthermore, the batteries of the plurality of satellite speakers 51, 52 may be charged through the base 30.

In order to charge the batteries of the plurality of satellite speakers 51, 52, the upper end portion 33 of the base 30 may be formed to allow charging of the batteries of the stored satellite speakers. As an example, the storage region provided on the upper end portion 33 of the base 30 may be formed to include a wireless charging pad for charging satellite speakers. Furthermore, the fixed portions of respective satellite speakers connecting the respective plurality of satellite speakers 51, 52 may be formed so as to transmit power supplied from the upper end portion 33 of the base 30 to another connected satellite speaker. Accordingly, when the plurality of satellite speakers 51, 52 are stacked as in FIG. 1A, power supplied from the upper end portion 33 of the base 30 may be supplied to each of the satellite speakers 51, 52 through the fixed portions connecting each of the satellite speakers 51, 52. Therefore, when the satellite speakers 51, 52 are stored in the upper end portion 33 of the base 30, the respective stored satellite speakers 51, 52 may be charged simultaneously.

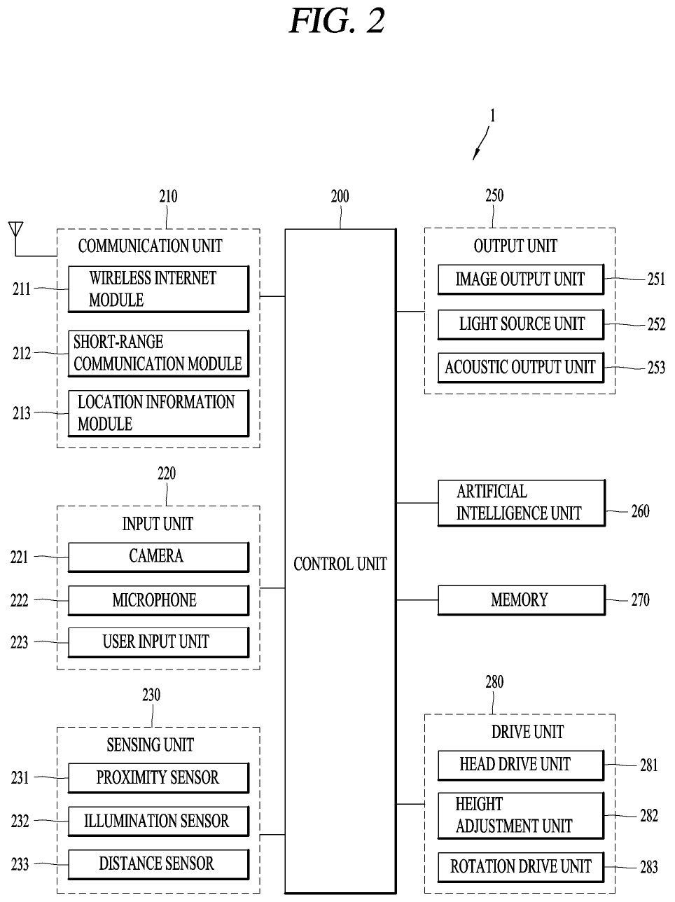

FIG. 2 is a block diagram showing a structure of the image projection device 1 according to an embodiment of the present disclosure.

Referring to FIG. 2, the image projection device 1 according to an embodiment of the present disclosure may be configured to include a control unit 200, and a communication unit 210, an input unit 220, a sensing unit 230, an output unit 250, an artificial intelligence unit 260, a memory 270, and a drive unit 280, which are connected to the control unit 200. However, the elements shown in FIG. 2 are not essential for implementing the image projection device 1, and thus the image projection device 1 described in this specification may have more or fewer elements than those listed above.

More specifically, among the elements, the communication unit 210 may include one or more modules that allows wireless communication between the image projection device 1 and a wireless communication system, between the image projection device 1 and at least one peripheral device, or between the image projection device 1 and an external server.

The communication unit 210 may include at least one of a wireless Internet module 211, a short-range communication module 212, and a location information module 213.

The wireless Internet module 211 refers to a module for wireless Internet access, and may be built into or external to the image projection device 1. The wireless Internet module 211 is configured to transmit and receive wireless signals in a communication network according to wireless Internet technologies.

The short-range communication module 212, which is provided for short-range communication, may support short-range communication using at least one of Bluetooth, RFID, infrared communication, UWB, ZigBee, NFC, Wi-Fi, Wi-Fi Direct, and Wireless USB technologies. The short-range communication module 212 may support wireless communication between the image projection device 1 and a wireless communication system, between the image projection device 1 and a peripheral device, or between the image projection device 1 and a network where an external server is located via wireless area networks.

The location information module 213 is a module for acquiring a location (or current location) of the image projection device 1, and a representative example thereof includes a global positioning system (GPS) module or a wireless fidelity (WiFi) module. For example, when the image projection device 1 utilizes a GPS module, the location of the image projection device 1 may be acquired by using signals sent from GPS satellites. As another example, when the image projection device 1 utilizes a Wi-Fi module, the location of the image projection device 1 may be acquired based on information from the Wi-Fi module and a wireless access point (AP) that transmits or receives a wireless signal.

As needed, the location information module 213 may perform any one function of the other modules of the communication unit 210 to alternatively or additionally obtain data regarding the location of the image projection device 1. The location information module 213, which is a module used to acquire the location (or current location) of the image projection device 1, is not limited to a module that directly calculates or acquires the location of the image projection device 1.

Meanwhile, as described above, the image projection device 1 according to an embodiment of the present disclosure may include at least one satellite speaker formed to be detachable from the main body (e.g., base 30) of the image projection device 1. Furthermore, the location information module 213 may be formed to acquire the location of each of at least one satellite speaker separated from the main body (e.g., base 30) of the image projection device 1. As an example, the location information module 213 may be formed to acquire the location of each of the satellite speakers based on at least one other device (e.g., wireless AP) that receives wireless signals detected from each of the separated satellite speakers.

The input unit 220 may include a camera 221 for inputting an image signal, a microphone 222 or an audio input module for inputting an audio signal, or a user input unit 223 (e.g., a touch key, a push key (or a mechanical key), etc.) for receiving information from the user. Voice data or image data collected from the input unit 220 may be analyzed to be processed as the user's control command.

Meanwhile, the camera 221 and the microphone 222 may respectively collect image and acoustic signals around the image projection device 1. In this case, the camera 221 may be provided with one or a plurality of image sensors, and may process an image frame, such as a still image or moving image, obtained by the image sensors. Furthermore, the processed image frame may be stored in the memory 270.

Additionally, the microphone 222 may sense an external acoustic signal and recognize the user's voice from the sensed acoustic signal. Various noise removal algorithms may be implemented in the microphone 122 to remove noise generated during a process of receiving an external acoustic signal.

Meanwhile, the sensing unit 230 may include one or more sensors for sensing at least one of information within the image projection device 1 and information on a surrounding environment around the acoustic recognition device 10. For example, the sensing unit 230 may include a proximity sensor 231, an illumination sensor 232, and a distance sensor 233. In this case, the distance sensor 233 may be a sensor for measuring a distance from a specific region where ultrasonic waves or laser reach to the image projection device 1 using the ultrasonic waves or laser. To this end, the distance sensor 233 may be a time-of-flight (TOF) sensor that calculates a distance at which the ultrasonic or laser wavelength is reflected from an object in terms of time.

Meanwhile, in addition to the proximity sensor 231, the illumination sensor 232, and the distance sensor 233, the sensing unit 230 may include at least one of an acceleration sensor, a magnetic sensor, a G-sensor, a gyroscope sensor, a motion sensor, an RGB sensor, an infrared (IR) sensor, a ultrasonic sensor, an optical sensor (e.g., see a camera 121), a microphone 122, an environment sensor (e.g., a barometer, a hygrometer, a thermometer, a radiation sensor, a thermal sensor, a gas sensor, etc.), and a chemical sensor (e.g., an electronic nose, a health care sensor, a biometric sensor, etc.). Meanwhile, the image projection device 1 disclosed in this specification may utilize information items sensed from at least two or more of those sensors in combination.

Meanwhile, the output unit 250 may include an image output unit 251 that outputs image information, a light source unit 252 for projecting light including the image information, and an acoustic output unit 253 that outputs an acoustic signal. Here, the image output unit 251 and the light source unit 252 may be mounted on the head 10 of the image projection device 1.

First, the light source unit 252 may include at least one light source that emits light. The light source may be a lamp or a laser light source. When the light source unit 252 is provided with a lamp as a light source, the lamp may be a lamp consisting of a low-power light emitted diode (LED).

Furthermore, the image output unit 251 may be a component formed to project an image using a digital micromirror device (DMD) through digital light processing (DLP). In this case, the image output unit 251 may generate light including image information by causing the light of the light source unit 252 colored through a color wheel to be reflected by the micromirrors provided in the DMD. Furthermore, the generated light may be irradiated in a direction faced by a front portion of the body of the head 10 through the light tunnel.

Meanwhile, the acoustic output unit 253 may output various audio data according to the control of the control unit 200. As an example, the acoustic output unit 253 may output an audio signal related to image information output through the image output unit 251 under the control of the control unit 200.

The acoustic output unit 253 is connected through the communication unit 210, and may include at least one satellite speaker formed to be detachable from the main body (e.g., base 30) of the image projection device 1. In this case, each satellite speaker may output different acoustic signals according to the control of the control unit 200, thereby implementing a stereo function.

Furthermore, the artificial intelligence unit 260, which performs a role of processing information items based on an artificial intelligence technology, may include at least one module that performs at least one of learning of information, inference of information, perception of information, and processing of a natural language.

Here, learning may be carried out through the machine learning technology. The machine learning technology is a technology that collects and learns a large amount of information items based on at least one algorithm, and determines and predicts information based on the learned information. The learning of information is an operation of identifying features, rules, determination references of information items, and the like, quantifying a relationship between information items, and predicting new data items using a quantified pattern.

The algorithm used by the machine learning technology may be an algorithm based on statistics, for example, a decision tree that uses a tree-structured form as a prediction model, an artificial neural network that mimics a neural network structure and function in a living organism, genetic programming based on an evolutionary algorithm in a living organism, clustering that distributes an observed example into a subset called a cluster, and a Monte Carlo method that calculates a function value as a probability using a randomly extracted random number.

A deep learning technology, as a branch of the machine learning technology, is a technology that performs at least one of learning, determining, and processing information items using an artificial neural network algorithm. An artificial neural network may have a structure that connects layers and transmits data between layers. The deep learning technology may learn a vast amount of information through an artificial neural network by using a GPU (graphics processing unit) optimized for parallel operations.

Meanwhile, in this specification, the artificial intelligence unit 260 and the control unit 200 may also be understood as the same element. In this case, a function performed in the control unit 200 described in this specification may be expressed as being performed in the artificial intelligence unit 260, and the control unit 200 may be named as the artificial intelligence unit 260, or conversely, the artificial intelligence unit 260 may be named as the control unit 200.

In addition, differently, in this specification, the artificial intelligence unit 260 and the control unit 200 may be understood as separate elements. In this case, the artificial intelligence unit 260 and the control unit 200 may perform various controls on the image projection device 1 by exchanging data with each other. The control unit 200 may change a region in which the image projection device 1 projects an image including image information or change a size of the projected image based on a result derived from the artificial intelligence unit 260. Alternatively, at least one of the elements of the image projection device 1 may be controlled to identify the user's voice command based on a result of recognizing and learning the user's voice and operate according to the identified voice command. Moreover, the artificial intelligence unit 260 may be operated under the control of the control unit 200.

Meanwhile, the drive unit 280 may be provided with at least one internal drive unit so as to allow at least one physical mechanism to be driven according to the control of the control unit 200.

For example, the drive unit 280 may include a head drive unit 281 that allows the head 10 to rotate in a pitch direction around the support 20 as an axis. The head drive unit 281 may include at least one motor or actuator provided on an inner side of the body of the head 10, and the control unit 200 may control the head drive unit 281 to adjust an angle at which the head 10 is tilted. Therefore, a direction faced by the front portion of the body of the head 10, that is, an angle in an up-down direction at which light is irradiated, may be controlled.

In addition, the drive unit 280 may include a height adjustment unit 282 that allows the support 20 to which the head 10 is connected to move along a vertical fastening groove formed on one side surface of the base rotation portion 31. The height adjustment unit 282 may include at least one motor or actuator provided on an inner side of the base rotation portion 31, and the control unit 200 may control the height adjustment unit 282 to adjust a distance by which the support 20 moves along the vertical fastening groove. Therefore, a height of the head 10 connected to the support 20 may be controlled.

In addition, the drive unit 280 may include a rotation drive unit 283 that causes the base rotation portion 31 to rotate around a central axis of the base support portion 32. The rotation drive unit 283 may include at least one motor or actuator provided on an inner side of the base rotation portion 31, and the control unit 200 may control the rotation drive unit 283 to adjust an angle at which the base rotation portion 31 rotates in a horizontal direction. Accordingly, the control unit 200 may rotate the base rotation portion 31 through the rotation drive unit 283, thereby horizontally rotating a direction faced by a front portion of the head 10 connected to the base rotation portion 31 through the support 20 by a predetermined angle.

In this manner, when there is control of the control unit 200, the drive unit 280 may drive at least one of the head drive unit 281, the height adjustment unit 282, and the rotation drive unit 283, thereby rotating a direction faced by the front portion of the head 10 in an up-down or horizontal direction, and changing a height of the front portion of the head 10. Therefore, the location of the image information projected in a direction faced by the front portion of the head 10 may be freely changed.

Meanwhile, the memory 270 may store data that supports the functions of the image projection device 1. The memory 270 may store a plurality of application programs (or applications) driven by the image projection device 1, data items for the operation of the image projection device 1, instructions, data items (e.g., learning data, voice recognition data) for the operation of the artificial intelligence unit 260, image information items to be projected through light from the light source unit 252, and acoustic data items related to each image information.

Additionally, the memory 270 may store information items on at least one peripheral device that can be connected to the image projection device 1. As an example, the memory 270 may store information of a designated remote controller (hereinafter referred to as a remote control). Additionally, the memory 270 may store information on devices that may be connected via wireless communication, such as a wireless AP or a cleaning robot. Additionally, information items provided from a preset external server may be stored, and information items on satellite speakers detachable from the main body of the image projection device 1 may be stored.

Additionally, the memory 270 may store information on a size and brightness of an image to be projected under the control of the control unit 200.

As an example, as a size of the image projected from the image projection device 1 increases, the concentration of the light projected from the light source unit 252 decreases, and thus the brightness of the projected image may decrease. On the contrary, as a size of the image projected from the image projection device 1 becomes smaller, the concentration of the light projected from the light source unit 252 increases, and thus the brightness of the projected image may increase. Therefore, when the illuminance of a region where the image is projected is high, if a size of the projected image is too large, then it may be difficult to identify the image due to a low brightness of the projected image.

Therefore, the image projection device 1 according to an embodiment of the present disclosure may limit a size of the projected image based on the illuminance of the region where the image is projected, thereby projecting a clearly identifiable image even when the illuminance of the region where the image is projected is high. To this end, the memory 270 may store information on a size of an appropriate projection image according to the illuminance of the region where the image is projected. In this case, a size of an appropriate projection image for each of the various illuminances may be determined according to an empirical rule obtained through several experimental results conducted in relation to the present disclosure.

Meanwhile, the control unit 200 controls each connected element, and may control an overall operation of the image projection device 1.

First, the control unit 200 may detect information related to image projection. For example, when a user utters a voice command that designates a specific region to project an image, or makes a gesture that designates a specific region at home, or when a plurality of satellite speakers are driven at locations spaced apart from each other to output stereo acoustics, or when a plurality of satellite speakers stored in the main body of the image projection device 1 are separated from the main body, it may be determined that there is the user's input for determining an image projection location. Furthermore, the image projection location may be determined based on the detected information.

Here, the control unit 200 may determine the image projection region based on a result of learning by the artificial intelligence unit 260. As an example, the control unit 200 may determine one region at home corresponding to the user's voice command as an image projection region based on a result of learning the user's voice command. Alternatively, the control unit 200 may determine one region at home pointed to by the user's gesture sensed through the camera 221 or light emitted from a designated remote control as an image projection region. To this end, the control unit 200 may use information collected from at least one peripheral device.

As an example, the control unit 200 may receive map information at the user's home collected from a wireless AP or a cleaning robot. Furthermore, the control unit 200 may map an image of a surrounding region identified from the camera 221 to the received map information to identify an indoor region (e.g., living room) where the image projection device 1 is located in a region at home. Accordingly, when the user requests image projection by referring to one side surface in an indoor region where the image projection device 1 is located (e.g., ‘play the movie AA in the living room’), the user's request may be recognized to project an image on a specific region of the recognized indoor space.

Meanwhile, when the image projection region is determined, the control unit 200 may control the drive unit 280 to face the determined image projection region. To this end, the control unit 200 may control at least one of the head drive unit 281, the height adjustment unit 282, and the rotation drive unit 283, and may detect a distance between the image projection region and the image projection device 1 and an angle at which the front portion of the head 10, that is, the output unit 250, faces the image projection region, that is, a pointing angle, through the distance sensor 233.

Furthermore, the control unit 200 may control the output unit 250 to project light including image information on an image projection region designated by the user. In this case, the control unit 200 may detect an illuminance of the image projection region and project an image according to a size of an appropriate projection image based on the detected illuminance. Alternatively, the control unit 200 may detect a size of an appropriate projection image based on the detected illuminance through a speaker, and guide the user on the detected size of the projection image.

Alternatively, the control unit 200 may calculate an image projection appropriateness for each wall surface at home when requested by the user. For example, the control unit 200 detects whether there is an obstacle and the illuminance of each wall surface in an indoor region where the image projection device 1 is located, and may recommend to the user which wall surface is most appropriate for image projection based on the detected illuminance. In this case, whether the image is appropriate for projection may be determined based on either a size of the image that can be output or a brightness of the image that can be output. Furthermore, when the user selects a wall surface as an image projection region according to a recommendation, the drive unit 280 may be controlled to determine the selected wall surface as an image projection region and face the determined image projection region.

Meanwhile, the control unit 200 may detect the color of the determined image projection region through the camera 221. Here, the color of the image projection region may be a wallpaper color on a wall surface designated as the image projection region. Therefore, the control unit 200 may calibrate the color of the image to be projected on the image projection region based on the detected wallpaper color. Here, the color calibration may color calibration to allow the color of the image projection region to be calibrated to achromatic white. Accordingly, even when the wallpaper color of the image projection region is not white, image information of accurate color may be irradiated.

Meanwhile, the size of the projected image may be determined not only by the illuminance but also by the user's selection. For example, the size of the projected image may be determined according to an arrangement state of satellite speakers separated from the main body of the image projection device 1. In this case, the size of the projected image may be determined according to a distance between the satellite speakers. That is, the user may designate an image projection region by detaching the satellite speakers from the main body and arranging the detached satellite speakers on a wall surface in a specific region at home where the image projection is desired. Furthermore, the satellite speakers may be arranged at a distance corresponding to the user's desired image size, thereby intuitively designating a size of the image to be projected. In this case, a separation distance between the satellite speakers may correspond to a horizontal length of the image to be projected.

In this case, the locations of the separated satellite speakers may be acquired in various ways. As an example, when the respective locations of the satellite speakers are acquired from the location information module 213, the control unit 200 may calculate a separation distance between the satellite speakers based on the locations of the satellite speakers acquired from the location information module 213. Furthermore, the size of the projection image may be determined based on the calculated separation distance.

Alternatively, the location information module 213 may only calculate a distance between each satellite speaker separated from the main body of the image projection device 1. In this case, the location information module 213 may calculate a distance between the main body of the image projection device 1 and each satellite speaker from a signal strength of each satellite speaker received from the communication unit 210. Alternatively, distances between the main body of the image projection device 1 and respective satellite speakers may be calculated based on a distance sensing value of the distance sensor 233 of the sensing unit 230. In this case, the distances may be calculated by a time-of-flight (TOF) required for a reflected signal for each satellite speaker to be received by the distance sensor 233.

Furthermore, the control unit 200 may detect a direction in which the satellite speakers are disposed based on the intensity of signals sensed from the satellite speakers. Then, the drive unit 280 may be controlled so as to allow the camera 221 to face the direction in which the satellite speakers are disposed. In this case, when the camera 221 is disposed on a front portion of the head 10, the front portion of the head 10 may face the direction in which the satellite speakers are disposed.

Meanwhile, when the camera 221 faces the direction in which the satellite speakers are disposed, the control unit 200 may acquire an image of the satellite speakers through the camera 221. Furthermore, an interval angle between the image projection device 1 with the main body of the image projection device 1 as a vertex and each satellite speaker may be calculated. Furthermore, when distances from the main body of the image projection device 1 to respective satellite speakers and interval angles between the image projection device 1 and respective satellite speakers are acquired, a distance between the satellite speakers may be calculated through a triangulation method. Furthermore, the size of the projection image may be determined based on the calculated separation distance.

Alternatively, the control unit 200 may calculate a distance between satellite speakers based on a wireless signal strength or a reflected signal arrival time (TOF) received at a satellite speaker from another satellite speaker. As an example, the control unit 200 may receive a signal reception result in which a second satellite speaker has received a wireless signal transmitted from a first satellite speaker, from the second satellite speaker, and may receive a signal reception result in which the first satellite speaker has received a wireless signal transmitted from the second satellite speaker, from the first satellite speaker. A distance between the first satellite speaker and the second satellite speaker may also be calculated based on a wireless signal strength of the second satellite speaker and a wireless signal strength of the first satellite speaker, respectively, received by the first and second satellite speakers, or a signal arrival time. Furthermore, the size of the projection image may be determined based on the calculated separation distance.

Additionally, the control unit 200 may detect an obstacle in a region where image information is projected when image information is projected. Furthermore, when an obstacle is detected, the image information may be projected by moving the region where the image information is projected or adjusting a size of the projected image information (e.g., reducing the size) to avoid the obstacle.

In addition, when projecting an image on a specific wall surface in an indoor region, the control unit 200 may compensate for image tilt that occurs depending on an angle at which the front portion of the head 10, that is, the output unit 250, faces the specific wall surface. Accordingly, even when the output unit 250 does not face the specific wall surface directly (vertically), a normal rectangular image without tilt may be projected on the specific wall surface.

Meanwhile, in the foregoing description, light from the light source unit 252 may be controlled to be output without image information. In this case, the image projection device 1 may also perform a function of illumination while outputting only light without image information. Furthermore, when operating as an illumination in this manner, the control unit 200 may of course lower the output of the light source unit 252 unlike when outputting image information.

When the image projection device 1 is used as an illumination as described above, the control unit 200 may change a location where the light of the illumination is projected based on a result of detecting a time, a user's location, or the like. As an example, according to a time or a user's location, the control unit 200 may control the drive unit 280 to project the illumination light around a location based on the time or the detected user's location. In this case, the control unit 200 may control the drive unit 280 so as to allow the output unit 250 to face a projection location determined by the control unit based on the time or the detected user's location.

Alternatively, the control unit 200 may control the output unit 250 to project light including specific image information according to the user's request when the image projection device 1 is used as an illumination. As an example, the control unit 200 may project image information provided from a peripheral device connected to the image projection device 1 on a region around the user based on a result of detecting the user's action. In this case, the peripheral device may be a mobile terminal carried by the user. Furthermore, the mobile terminal may include a smart phone, a laptop computer, a digital broadcasting terminal, a personal digital assistant (PDA), a portable multimedia player (PMP), a slate PC, a tablet PC, an ultrabook, a wearable device (e.g., a smartwatch), and the like.

Alternatively, the image projection device 1 may be connected to a preset server. As an example, the image projection 1 may be connected to a weather information providing server that provides current temperature and weather information. In this case, the image projection device 1 may control the output unit 250 and the drive unit 280 to project light including weather information provided from the weather information providing server around the user according to the user's request. In this case, the image projection device 1 may be used as an artificial intelligence assistant that provides various information requested by the user.

At least some of the elements may operate cooperatively with one another to implement the operation, control, or control method of the image projection device 1 according to various embodiments described below. In addition, the operation, control, or control method of the image projection device 1 may be implemented on the image projection device 1 by driving at least one application program stored in the memory 270.

Hereinafter, embodiments related to a control method that can be implemented in the image projection device 1 having such a configuration will be described with reference to the accompanying drawings. It is obvious to those skilled in the art that the present disclosure can be embodied in other specific forms without departing from the concept and essential characteristics thereof.

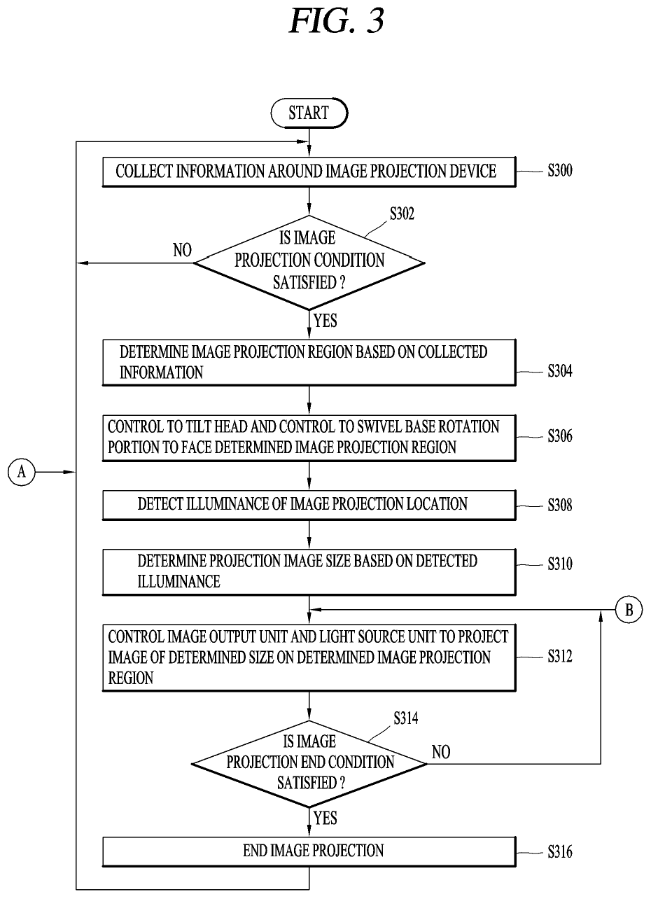

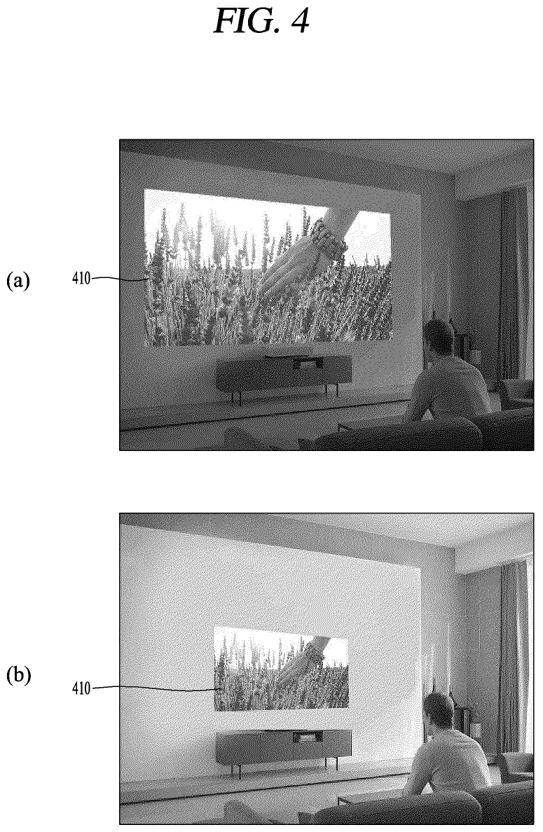

FIG. 3 is a flowchart showing an operation process of determining, by the image projection device 1 according to an embodiment of the present disclosure, an image projection region and projecting an image. Furthermore, FIG. 4 is an exemplary diagram showing examples of projecting, by an image projection device according to an embodiment of the present disclosure, images in different sizes depending on an illuminance of an image projection region.

First, referring to FIG. 3, the control unit 200 of the image projection device 1 according to an embodiment of the present disclosure may collect information on the image projection device 1 and around the image projection device 1 (S300). Here, information on the image projection device 1 and around the image projection device 1 may be the user's voice or the user's gesture sensed around the image projection device 1. Alternatively, it may be information detecting whether the satellite speakers 51, 52 are separated from the image projection device 1. That is, the information on the image projection device 1 and around the image projection device 1 may be information for determining whether the user has selected image projection.

Furthermore, the control unit 200 may determine whether the user has selected image projection based on information collected in the step S300 (S302). Furthermore, when it is determined that the user has selected image projection as a result of the determination in step S302, a specific indoor region where the image is to be projected, that is, an image projection region, may be determined based on the information detected in the step S300 (S304).

For example, as a result of identifying the user's voice collected in the step S300, when voice information indicating a specific indoor region (e.g., a wall in a living room) and voice information indicating image information to be projected (e.g., the movie AAA) are included, the control unit 200 may determine that the user has selected image projection.

To this end, the control unit 200 may detect whether the image projection device 1 is located in which indoor region among regions that can be divided at home based on map information at home collected from a peripheral device of the image projection device 1. As an example, the control unit 200 may perform a communication connection with the cleaning robot when the cleaning robot approaches the image projection device 1, and may receive map information at home collected by the cleaning robot from the cleaning robot. Furthermore, depending on a location of the cleaning robot close to the image projection device 1, an indoor region where the image projection device 1 is currently disposed may be identified from the map information at home.

Furthermore, the control unit 200 may detect a specific indoor region (e.g., ‘living room’) corresponding to the identified user's voice information from the map information at home. In this case, each region included in the map information of the indoor region may be a region whose name has been previously designated through the peripheral device. Furthermore, when a specific indoor region having a name corresponding to the user's voice information identified from the map information at home is detected, the process proceeds to step S304, and based on the detected specific indoor region and the identified voice information, one of the wall surfaces of the indoor region where the image projection device 1 is disposed may be determined as an image projection region.

Alternatively, when the user utters information on image information to be projected along with a gesture pointing to a specific region at home, the control unit 200 may collect the gesture and the image information in the step S300. Furthermore, based on the sensed gesture and image information in the step S302, it may be determined that the user has selected image projection. Then, the process proceeds to step S304, one wall surface located in a direction indicated by the gesture, for example, in a direction pointed to by the user's fingertip, may be determined as an image projection region, from among wall surfaces in an indoor region where the image projection device 1 is disposed.

Alternatively, information collected from the image projection device 1 or around the image projection device 1 may be a light signal emitted from a designated remote control. In this case, when a light output from the designated remote control is sensed, the control unit 200 may track the light signal sensed from the camera 221, and detect a wall surface pointed to by the light signal. Then, the process proceeds to step S304, and one wall surface of the detected indoor region may be determined as an image projection region.

When a region where the image is to be projected is determined in the step S304, the control unit 200 may control the drive unit 280 to face the determined image projection region (S306). For example, the control unit 200 may change horizontal and vertical directions faced by the front portion of the head 10, that is, the output unit 250, so as to face a direction according to the image projection region determined in step S306. In this case, in order to change the horizontal direction, the control unit 200 may control the rotation drive unit 283 to swivel the base rotation portion 31, and in order to change the vertical direction, the control unit 200 may control the head drive unit 281 to tilt the head 10 at a predetermined angle, or control the height adjustment unit 282 to change a height of the head 10.

Here, a height of the image projection region may be previously designated. In this case, the control unit 200 may control the head drive unit 281 and the height adjustment unit 282 to face a location of the image projection region designated at a designated height.

Additionally, a height of the image projection region may be determined based on a result of learning by the artificial intelligence unit 260. As an example, when a specific user requests image projection, in a case where a height of the image projection region is modified to a higher or lower location than an automatically set height, the control unit 200 may learn a height of the image projection region preferred by the specific user along with a result of identifying the specific user. Furthermore, when the learning of the artificial intelligence unit 260 is completed based on learning data collected over a predetermined period of time (e.g., height data of the modified image projection region), the control unit 200 may determine, as a result of identifying a user, a height of the image projection region based on a learning result of the artificial intelligence unit 260 when the identified user is the specific user.

Meanwhile, as a size of the image projected from the image projection device 1 increases, the concentration of the light projected from the light source unit 252 may decrease. Therefore, a brightness of the projected image may be reduced. On the contrary, the smaller the size of the image projected from the image projection device 1, the higher the concentration of the light projected from the light source 252. Therefore, the brightness of the projected image may be increased.

However, in a case where an illuminance of the determined image projection region is low, the brightness of the projected image may be a predetermined level higher than the ambient illumination even when the size of the projected image is large. Therefore, even when the size of the projected image is large, the projected image may appear clear because the projected image is sufficiently bright.

However, in a case where an illuminance of the determined image projection region is high, when the size of the projected image is large, the brightness of the projected image may be lower than or similar to the illuminance of the image projection region. In this case, the brightness of the projected image may not be bright enough compared to the surrounding region, so the projected image may not appear clear. Accordingly, the size of the projected image may be limited to maintain a predetermined level of difference in brightness between the ambient illuminance and the projected image.

Therefore, in the step S306, when the front portion of the head 10, that is, the output unit 250, faces the image projection region determined in the step S304 through the control of the driving unit 280, the control unit 200 may detect an illuminance of the determined image projection region (S308). Furthermore, based on the detected illuminance of the image projection region, a size of the image to be projected on the image projection region may be determined (S310). In this case, a size of the projection image determined based on the detected illuminance may be smaller as the detected illuminance has a larger value, and may be larger as the detected illuminance has a smaller value. A size of the projection image corresponding to the detected illuminance may be determined according to an empirical rule obtained through several experimental results conducted in relation to the present disclosure.

Meanwhile, in the step S310, when the size of the image to be projected is determined based on the detected illuminance, the control unit 200 may control the image output unit 251 and the light source unit 252 to project an image of the determined size on the determined image projection region (S312). In this case, the control unit 200 may control the acoustic output unit 253 to output acoustic information related to the output image.

FIG. 4 is an exemplary diagram showing examples of projecting, by the image projection device 1 according to an embodiment of the present disclosure, images in different sizes depending on an illuminance of an image projection region.

First, referring to (a) of FIG. 4, an example is shown in which the illuminance of the determined image projection region is low (e.g., at night). In this case, as shown in (a) of FIG. 4, the image projection device 1 may output a large screen image of 120 inches in size. In this case, a brightness of the large screen image may be 2000 ANSI lumens.

In contrast, (b) of FIG. 4 shows an example in which a illuminance of the determined image projection region is high (e.g., in the daytime). In this case, as shown in (b) of FIG. 4, the image projection device 1 may project an image reduced to 60 inches, that is, a ¼ size image, on the image projection region as the illuminance of the image projection region is bright. In this case, as the size of the projection image is reduced, the concentration of the light projected from the light source unit 252 increases, so the brightness of the reduced image may increase to 6000 to 8000 ANSI lumens.

Therefore, the image projection device 1 according to an embodiment of the present disclosure may automatically adjust, when the illuminance of the determined image projection region is high, the output unit 250 so as to allow a clear and bright image to be projected despite a high ambient illuminance by reducing a size of the projection image and increasing the concentration.

Meanwhile, in the step S312, when the image output unit 251 and the light source unit 252 are controlled to project an image on the determined image projection region, the control unit 200 may detect whether a condition for ending the image projection is satisfied (S314). For example, when all images requested for projection have been played, or when a designated image projection time has expired, the control unit 200 may determine that a condition for ending the image projection is satisfied. Alternatively, the control unit 200 may determine, when the user requests to end image projection or when the user is not detected for a predetermined period of time, that a condition for ending the image projection is satisfied.

As a result of the determination in the step S314, when it is not determined that an image projection condition is satisfied, the control unit 200 may proceed to the step S312 to maintain a state in which the image output unit 251 and the light source unit 252 are controlled to project an image on the determined image projection region. However, as a result of the determination in the step S314, it is determined that an image projection condition is satisfied, the control unit 200 may control the light source unit 252 and the image output unit 251 to end the image projection (S316). Furthermore, when the image projection is ended, the process proceeds to step S300 again to collect information on the image projection device 1 and around the image projection device 1 again. Furthermore, depending on the information collected, the process from the step S300 to step S316 may be performed again.

Meanwhile, according to the foregoing description, it has been described that the image projection device 1 according to an embodiment of the present disclosure is provided with a plurality of detachable satellite speakers, and a region where the image is to be projected and a size of the image to be projected can be determined according to an arrangement location and arrangement state of the satellite speakers.

In this case, information collected from the image projection device 1 or around the image projection device 1 in the step S300 may be a separation between satellite speakers and location information of the separated satellite speakers. For example, when a user separates satellite speakers stored in the main body of the image projection device 1 from the main body, the control unit 200 may detect a separation between the satellite speakers. Then, the control unit 200 may detect the locations of the separated satellite speakers and determine a wall surface of an indoor region corresponding to the detected locations of the satellite speakers as an image projection region.

In this case, the control unit 200 may detect a distance between the separated satellite speakers and determine whether image projection is appropriate based on the detected distance between the satellite speakers. Furthermore, the control unit 200 may determine a size of the image to be projected, and may proceed to the step S312 to control the image output unit 251 and the light source unit 252 so as to allow the image to be projected according to the determined size.

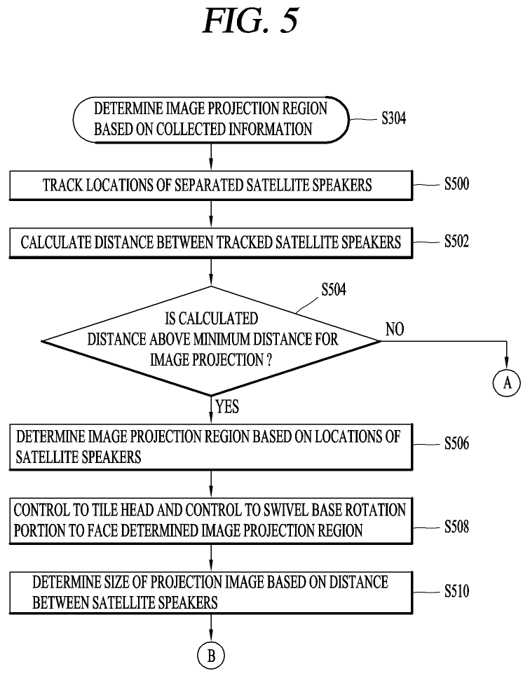

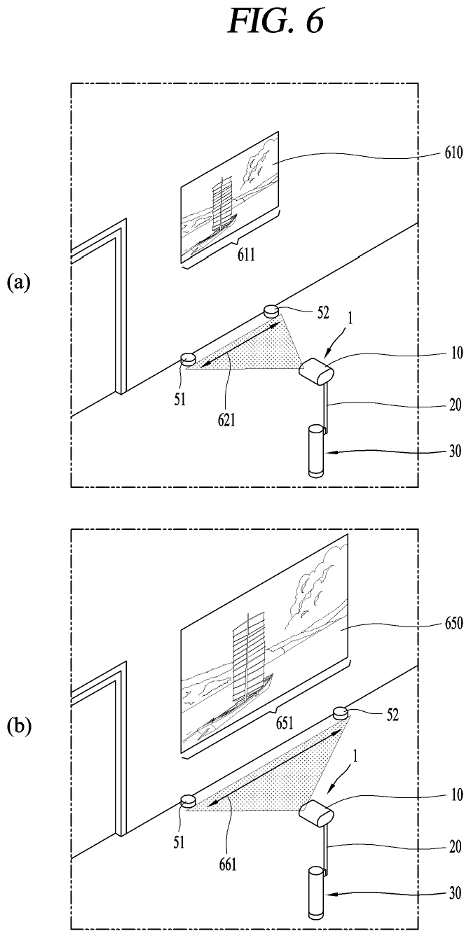

FIG. 5 is a flowchart showing an operation process of determining, by the image projection device 1 according to an embodiment of the present disclosure, an image projection region and a size of an image to be projected based on the locations of separate satellite speakers as described above. Furthermore, FIG. 6 is an exemplary diagram showing examples of determining, by the image projection device 1 according to an embodiment of the present disclosure, an image projection region and a size of an image to be projected based on the locations of satellite speakers 51, 52.

First, referring to FIG. 5, the control unit 200 of the image projection device 1 according to an embodiment of the present disclosure may track the locations of the satellite speakers 51, 52 separated from the main body (e.g., base 30) of the image projection device 1 when one wall surface of an indoor region is determined as an image projection region based on the information items collected in the step S304 of FIG. 3 (S500). Furthermore, from the detected locations of the satellite speakers 51, 52, a straight-line distance between the satellite speakers 51, 52 may be calculated (S502).

For example, the locations of the satellite speakers 51, 52 may be detected from the location information module 213. In this case, the control unit 200 may calculate a distance between the satellite speakers 51, 52 detected from the location information module 213 in the step S502.

Alternatively, the locations of the satellite speakers 51, 52 may be calculated based on distances between the respective satellite speakers 51, 52 and the main body of the image projection device 1 detected by the location information module 213 or the distance sensor 233, and interval angles between virtual extension lines connecting the respective satellite speakers 51, 52 to the main body of the image projection device 1 as a vertex, which are acquired from the camera 221. In this case, the control unit 200 may calculate a straight-line distance between the satellite speakers 51, 52 based on the interval angle and distances between the main body of the image projection device 1 and the respective satellite speakers 51, 52 using a triangulation method in the step S502.

Alternatively, the locations of the satellite speakers 51, 52 may be detected from a wireless signal strength received from each satellite speaker to another satellite speaker. As an example, the communication unit 210 may receive, from a first satellite speaker 51, a result of detecting an intensity of a second wireless signal transmitted from a second satellite speaker 52 or information on a time at which the second wireless signal has reached the first satellite speaker 51. Furthermore, the communication unit 210 may receive, from the second satellite speaker 52, a result of detecting an intensity of a first wireless signal transmitted from the first satellite speaker 51, or information on a time at which the first wireless signal has reached the second satellite speaker 52. Then, in the step S502, the control unit 200 may calculate a distance between the first satellite speaker 51 and the second satellite speaker 52 based on an intensity of each of the first wireless signal and the second wireless signal, or a time at which the first wireless signal and the second wireless signal have reached each of the different satellite speakers.

In the step S502, when the distance between the satellite speakers 51, 52 is calculated, the control unit 200 may determine whether the calculated distance is above a preset minimum distance for image projection (S504). Furthermore, when the distance between the satellite speakers 51, 52 calculated in the step S502 is below a minimum distance for image projection, it may be determined that the separation between the satellite speakers 51, 52 sensed in the step S300 is not for image projection. Therefore, the control unit 200 may proceed to step S300 again, and determine again whether the satellite speakers 51, 52 have been separated from the main body (e.g., base 30) of the image projection device 1 in step S300.

Accordingly, when the satellite speakers 51, 52 continue to remain separated from the main body, the control unit 200 may repeat a process from the steps S300 and S302 of FIG. 3 to the steps S500 and S502. In this case, as a result of the determination in the step S504, when a distance between the satellite speakers 51, 52 is below a minimum distance for image projection, a guidance message notifying that the distance between the satellite speakers 51, 52 currently separated from the main body is inappropriate for image projection may be output through the acoustic output unit 253.

Meanwhile, the guidance message may further include a message to confirm the user's intention to project the image to the user. Furthermore, in response to the guidance message, when it is confirmed that the user does not want to project the image, the control unit 200 may not perform a process of tracking the locations of the satellite speakers 51, 52 (S500) and a process of calculating a distance between the satellite speakers 51, 52 (S502) until the satellite speakers 51, 52 are stored back into the main body of the image projection device 1. In this case, when the satellite speakers 51, 52 are stored back into the main body of the image projection device 1, the control unit 200 may start the process of FIG. 3 again.

Meanwhile, as a result of the determination in the step S504, when a distance between the satellite speakers 51, 52 is below a minimum distance for the image projection, the control unit 200 may detect one region of an indoor region corresponding to a direction in which the satellite speakers 51, 52 are disposed as a region where the image is to be projected (S506). As an example, the control unit 200 detects a direction in which a strength of a wireless signal received from each satellite speaker 51, 52 is the strongest, and may detect one region in the indoor region corresponding to the detected direction through the camera 221. Furthermore, the detected one region may be determined as the image projection region.

When the image projection region is determined in the step S506, the control unit 200 may control the drive unit 280 to face the determined image projection region (S508). For example, the control unit 200 may control at least one of the head drive unit 281, the height adjustment unit 282, and the rotation drive unit 283 according to the image projection region determined in the step S506 to swivel the base rotation portion 31 or tilt the head 10. Additionally, a height of the head 10 may be adjusted. Accordingly, the front portion of the head 10, that is, the output unit 250, may be rotated horizontally or vertically or the height of the head may be changed to face the image projection region.

Furthermore, the control unit 200 may determine a size of the image to be projected based on the distance between the satellite speakers 51, 52 calculated in the step S502 (S510). Here, the control unit 200 may determine a horizontal axis length of the image to be projected based on the distance between the satellite speakers 51, 52 calculated in the step S502. Therefore, a size of the projection image may be determined such that the horizontal length corresponds to the distance between the satellite speakers 51, 52. Then, the control unit 200 proceeds to step S312 of FIG. 3, and may control the image output unit 251 and the light source unit 252 to project an image according to the currently determined size of the projection image. Accordingly, an image having a horizontal length corresponding to the distance between the satellite speakers 51, 52 determined in the step S510 of FIG. 5 may be projected on an image projection region according to the location where the satellite speakers 51, 52 are disposed.

FIG. 6 is an exemplary diagram showing examples of determining, by the image projection device 1 according to an embodiment of the present disclosure, an image projection region and a size of an image to be projected based on the locations of satellite speakers 51, 52 as described above.

As shown in (a) and (b) of FIG. 6, when a user places satellite speakers 51, 52 on a specific wall surface of an indoor region where an image is desired to be projected, the control unit 200 may track the locations of the satellite speakers 51, 52 separated from the main body (e.g., base 30) to detect a direction in which the satellite speakers 51, 52 are disposed. Furthermore, a specific wall surface of an indoor region where the satellite speakers 51, 52 are disposed may be detected, and the detected specific wall surface may be determined as an image projection region. In this case, the control unit 200 may use an image acquired from the camera 221 to detect the specific wall surface.

When a specific wall surface in an indoor region is determined as an image projection region based on the location where the satellite speakers 51, 52 are disposed, the control unit 200 may determine a size of the image to be projected based on a result of calculating the distance between the satellite speakers 51, 52. To this end, the control unit 200 may use the locations of the satellite speakers 51, 52 detected by the location information module 213 or a wireless signal strength of another satellite speaker detected from each of the satellite speakers 51, 52. Alternatively, as shown in (a) and (b) of FIG. 6, the distance between the satellite speakers 51, 52 may be calculated from a triangle formed by the image projection device 1 and the respective satellite speakers 51, 52 with the image projection device 1 as a vertex.

For example, the control unit 200 may calculate an interval angle between a line segment connecting the first satellite speaker 51 and the image projection device 1 and a line segment connecting the second satellite speaker 51 and the image projection device 1 based on an image acquired from the image projection device 1 determined according to the locations of the satellite speakers 51, 52. Then, the control unit 200 may calculate a distance between the first and second satellite speakers 51, 52 based on distances between the first and second satellite speakers 51, 52 and the image projection device 1 and the calculated interval angle according to a triangulation method.

Meanwhile, a distance between the satellite speakers 51, 52 may vary depending on a state in which the satellite speakers 51, 52 are disposed. For example, (a) of FIG. 6 and (b) of FIG. 6 show examples of cases where the distance between satellite speakers 51, 52 is different depending on an arrangement state of the satellite speakers 51, 52. In this case, (a) of FIG. 6 assumes a case where the distance between the satellite speakers 51, 52 is smaller, and (b) of FIG. 6 assumes a case where the distance between the satellite speakers 51, 52 is larger.

When the satellite speakers 51, 52 are disposed as shown in (a) of FIG. 6, the control unit 200 may determine a length of a horizontal axis 611 of an image (first image) 610 to be projected on an image projection region to be the same length as a distance (first distance) 621 between the satellite speakers 51, 52 calculated according to an arrangement state of the satellite speakers 51, 52. Furthermore, when the length of the horizontal axis 611 is determined, a size of the image to be projected may be determined according to the determined length of the horizontal axis 611. As an example, when a screen ratio is 4:3 or 16:9, a size of the first image 610 may have a vertical length corresponding to ¾ or 9/16 of the determined length of the horizontal axis 611. Furthermore, the control unit 200 may control the acoustic output unit 253 and the light source unit 252 to project the first image 610 according to the determined size of the projection image on the image projection region.

Meanwhile, when the first and second satellite speakers 51, 52 are spaced further apart from each other than in a case shown in (b) of FIG. 6, the control unit 200 may determine a length of the horizontal axis 651 of the image (second image) 650 to be projected on the image projection region according to a larger separation distance (second distance) 661 between the satellite speakers 51, 52. Therefore, when the distance between the satellite speakers 51, 52 becomes larger, a size of the projection image having a larger length of the horizontal axis 651 may be determined.

Furthermore, as the horizontal axis length of the image becomes larger, a vertical axis length of the image may also become larger depending on a screen ratio of the image to be projected. As a result, as shown in the second image 650 in (b) of FIG. 6, when the distance between the satellite speakers 51, 52 becomes larger, a size of the projected image may become larger. In addition, conversely, when the distance between the satellite speakers 51, 52 becomes smaller, a size of the projected image may become smaller. Accordingly, the user may set a size of the projected image as well as designate a region where the image is to be projected by changing a location where the satellite speakers 51, 52 are disposed.

Meanwhile, according to the foregoing description, it has been described that the image projection device 1 according to an embodiment of the present disclosure may designate a specific wall surface in an indoor region as an image projection region using a designated remote control.

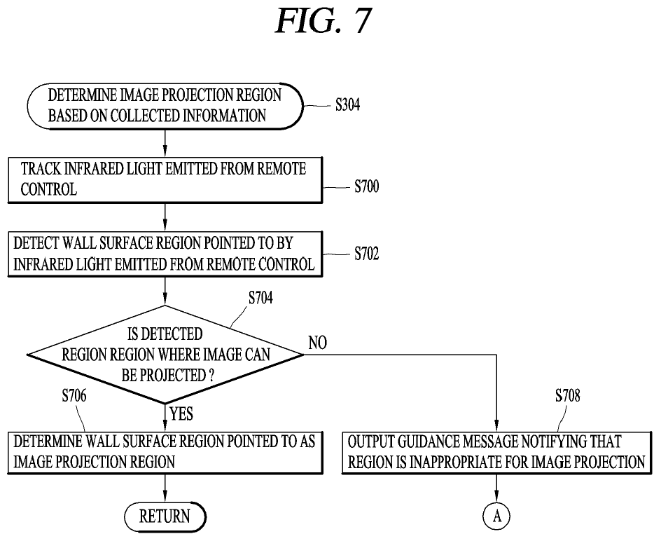

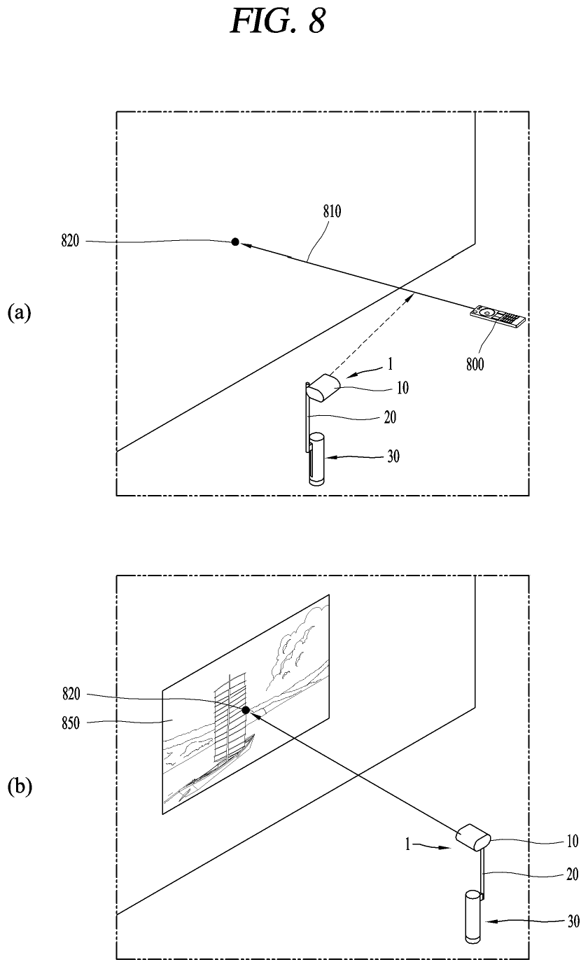

FIG. 7 is a flowchart showing an operation process of determining, by the image projection device 1 according to an embodiment of the present disclosure, a specific wall surface designated via a remote control as an image projection region. In addition, FIG. 8 is an exemplary diagram showing an example of determining, by the image projection device 1, a specific wall surface designated via a remote control as an image projection region.

First, referring to FIG. 7, in the step S304 of FIG. 3, the control unit 200 may collect an operation signal of a designated remote control as information around the image projection device 1. As an example, when a preset key is input from a designated remote control, the control unit 200 may detect a key input signal from the remote control in the step S304 of FIG. 3 and track a light signal, for example, an infrared signal, emitted from the remote control (S700). Furthermore, a specific wall surface of an indoor region pointed to by the tracked light signal of the remote control may be detected (S702).

As an example, the control unit 200 may track a trajectory of a light signal acquired through the camera 221, as shown in (a) of FIG. 8. That is, when an input of a preset key is detected from a designated remote control, the control unit 200 may detect the remote control 800 from an image acquired through the camera 221 and detect a light signal emitted from the remote control 800. Furthermore, the control unit 200 may move along the detected light signal of the remote control to detect a specific wall surface of an indoor region pointed to 820 by the light signal.

Here, when an input of the preset key is ended, the control unit 200 may detect a specific wall surface of an indoor region pointed to 820 by the light signal 810 through an image acquired when the input of the preset key is detected. To this end, the control unit 200 may store an image including a wall surface of each indoor region around the image projection region when the input of the preset key is detected, and may also detect the specific wall surface pointed to 820 by the light signal 810 based on the stored image.

When a specific wall surface pointed to by the light signal 810 of the remote control 800 is detected, the control unit 200 may determine whether the detected specific wall surface is a region where an image can be projected (S704). For example, the control unit 200 may determine whether a specific wall surface pointed to by the light signal 810 includes a minimum region where an image can be projected.

As an example, the control unit 200 may acquire an image of a specific wall surface pointed to by the light signal 810 in the step S704. Furthermore, from the acquired image of the specific wall surface, the control unit 200 may detect whether the specific wall surface includes a flat surface on which an image can be projected, that is, a region with a surface curvature below a preset level, above a preset minimum size. Furthermore, based on a result of detecting the surface, it may be determined whether the specific wall surface is a region where an image can be projected.

As a result of the determination in the step S704, when a specific wall surface pointed to by the light signal 810 is a region where an image can be projected, the control unit 200 may determine a wall surface region pointed to by the light signal 810 as an image projection region. Then, the control unit 200 may proceed to step S306 of FIG. 3 to control the rotation drive unit 283 to swivel the base rotation portion 31 so as to face the determined image projection region. Furthermore, the head driving unit 281 and height adjustment unit 282 may be controlled to face a location of the image projection region designated at a designated height.

Furthermore, the control unit 200 may proceed to steps below step S308 of FIG. 3 to control the acoustic output unit 253 and the light source unit 252 so as to project an image on the image projection region. Accordingly, as shown in (b) of FIG. 8, an image 850 designated by the user may be projected on a specific wall surface pointed to 820 by the light signal 810. In this case, a size of the projected image 850 may vary depending on a illuminance detected from a specific wall surface pointed to 820 by the light signal 810.

Here, the control unit 200 may determine, in the step S704, a region where an image can be projected, which is detected from the image of the specific wall surface (e.g., a flat surface above a preset minimum size), as the image projection region. Additionally, the control unit 200 may automatically determine a size of the image to be projected based on a size of the region where the image can be projected, which is detected from the specific wall surface. In this case, even when the illuminance detected from the specific wall surface is sufficiently low, a size of the image projected on the specific wall surface may be reduced depending on a surface curvature state of the specific wall surface.

Meanwhile, in the step S704, when the specific wall surface pointed to by the light signal does not include a region where an image can be projected, the control unit 200 may output a guidance message notifying that the region is inappropriate for image projection (S708). Furthermore, the control unit 200 may proceed again to step S300 of FIG. 3 to collect information on the image projection device 1 and around the image projection device 1. In this case, when the user points to another indoor region using the remote control 800, the process may proceed to the step S304 through the step S302 of FIG. 3 and perform the operation process of FIG. 7 again.

Meanwhile, the image projection device 1 according to an embodiment of the present disclosure may of course recommend a region appropriate for image projection to the user based on a result of finding a surrounding wall surface region.

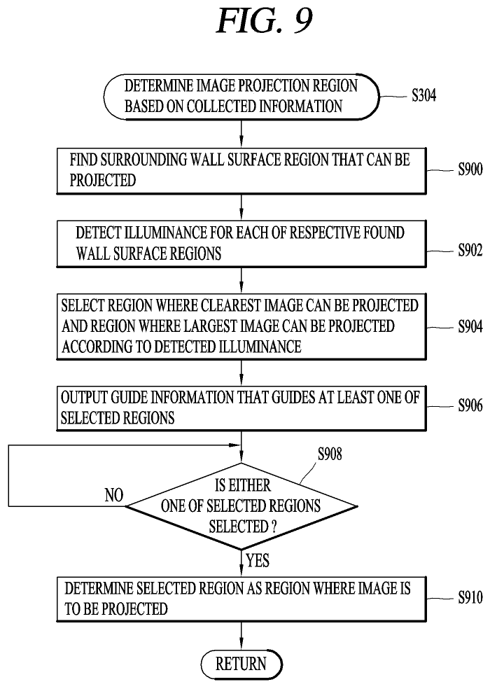

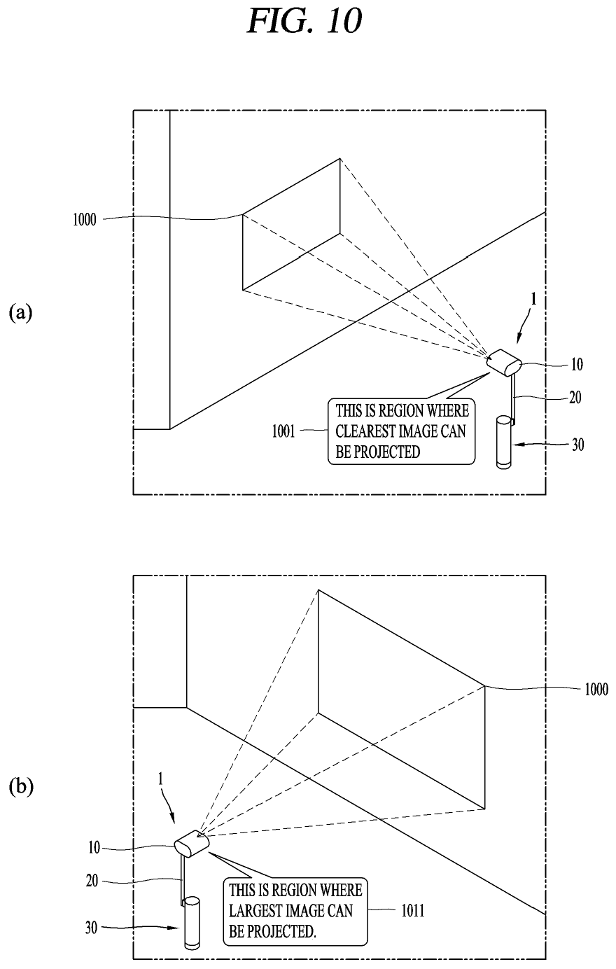

FIG. 9 is a flowchart showing an operation process of recommending, by the image projection device 1, an image projection region to a user based on a result of finding a surrounding wall surface region in such a case. Furthermore, FIG. 10 is exemplary diagrams showing examples of recommending, by the image projection device 1, image projection regions, respectively, selected according to different conditions as a result of finding the surrounding wall surface region to the user.

First, referring to FIG. 9, the control unit 200 of the image projection device 1 may detect a region where an image can be projected from among respective wall surface regions in an indoor region where the image projection device 1 is disposed when the user selects image projection based on information collected in the step S302 of FIG. 3 (S900). Here, whether the image can be projected may be determined depending on whether there is an obstacle and whether an area of a region whose surface curvature is below a preset level is above a preset minimum area. To this end, the control unit 200 may control the rotation drive unit 283 to allow the base rotation portion 31 to swivel around the base support portion 32 as an axis. Therefore, as the base rotation portion 31 or the front portion of the head 10, that is, the output unit 250, is swiveled horizontally around the base 30 as an axis, images of different wall surfaces in an indoor region may be acquired through the camera 221 disposed on the body of the base rotation portion 31 or the output unit 250.

Then, the control unit 200 may detect at least one wall surface region where an image can be projected based on whether there is an obstacle from the acquired images and whether an area of the region whose surface curvature is below a preset level is above a preset minimum area. For example, when there is an obstacle above a preset size that covers the detected wall surface, or even when there is no obstacle that covers the wall surface, a wall surface having a complex surface shape and having a surface curvature above a predetermined level, or a wall surface having an area of the region whose surface curvature is below a preset level is below a preset minimum area for image projection may be a region where an image cannot be projected. Furthermore, at least one wall surface that satisfies the conditions, that is, there is no obstacle, a surface curvature is below a predetermined level, or a region where the surface curvature is below a preset level is above a preset minimum area, may be determined as a wall surface region where an image can be projected.

Then, the control unit 200 may detect an illuminance for each of at least one wall surface region where an image can be projected, which is found in the step S900 (S902). Furthermore, the control unit 200 may select a wall surface region where the clearest image can be projected and a wall surface region where the largest image can be projected based on the detected illuminance (S904).

For example, the control unit 200 may select a wall surface region with the lowest detected illuminance as a region where the largest image can be projected, and may select a wall surface region with the highest detected illuminance as a region where the clearest image, that is, the brightest image, can be projected.

Alternatively, the control unit 200 may calculate a brightness of an image that can be projected on the wall surface based on an area of a region where an image can be projected, which is detected from a wall surface image. For example, when an area of a region where an image can be projected is narrow, a size where the image can be projected may be reduced accordingly. Then, the light concentration increases depending on a size of the image, so a brightness of the image to be projected may be brighter. That is, regardless of an illuminance detected from the wall surface, a brightness (e.g., ANSI lumens) of the image to be projected may be determined based on a size of the region where the image can be projected.

Furthermore, the control unit 200 may select at least one of respective wall surface regions where an image can be projected, depending on different conditions, that is, whether the clearest image (an image with the highest brightness (e.g., ANSI lumens)) can be projected or the largest image can be projected, and output guide information for guiding the user to the selected wall surface region (S906).

As an example, the guide information may be a light signal pointing to a specific wall surface or indicating a guide line corresponding to a size of an image that can be projected on the specific wall surface. In this case, the light signal may be a laser.

FIG. 10 shows examples of recommending to a user image projection regions respectively selected according to different conditions as a result of finding surrounding wall surface regions.

First, referring to (a) of FIG. 10, (a) of FIG. 10 shows an example in which guide information is output to guide the user to a region where the brightest image can be projected according to the highest illuminance as a result of finding the wall surface regions. In this case, the control unit 200 may control the drive unit 280 to allow the head 10 to face a wall surface region where the brightest image can be projected.

Furthermore, at the same time as outputting an acoustic message indicating a region where the clearest image can be output, a guide line 1000 indicating a size of the region that can be projected according to an illuminance detected from the wall surface region on which the brightest image can be projected may be displayed. Therefore, information on a wall surface region on which the clearest image can be projected and a size of the region that can be projected in the wall surface region may also be provided to the user.

On the contrary, (b) of FIG. 10 shows an example in which guide information is output to guide the user to a region where the largest image can be projected according to the lowest illuminance as a result of finding the wall surface regions. In this case, the control unit 200 may control the drive unit 280 to allow the head 10 to face the wall surface region where the largest image can be projected. In this case, as shown above in (b) of FIG. 10, the wall surface region on which the largest image can be projected may be a different wall surface region from that on which the clearest image can be projected.

Furthermore, at the same time as outputting an acoustic message indicating a region where the largest image can be output, a guide line 1000 indicating a size of the region that can be projected may be displayed on the wall surface region where the largest image can be projected. Therefore, information on the wall surface region on which the largest image can be projected and a size of the region that can be projected in the wall surface region may also be provided to the user.

Meanwhile, in FIG. 10, although an example has been described in which a guide line 1000 corresponding to a size of the region that can be projected on the wall surface is displayed, this is only an example to help understand the present disclosure, and the present disclosure is of course not limited thereto. For example, the control unit 200 may project at least one number, letter, or shape representing a light point pointing to the wall surface or a size corresponding to the size of the region that can be projected on the wall surface. In this case, the user may also estimate a size of the region that can be projected on the wall surface based on a size of the light point or numbers, letters, or shapes projected on the wall surface.

Meanwhile, in FIG. 10, although an example has been described in which different wall surfaces selected according to different conditions, that is, a wall surface on which the clearest image can be projected and a wall surface on which the largest image can be projected are both guided to the user, only information on a wall surface corresponding to either one of the above conditions may also of course be provided depending on the user's selection or preset settings. In this case, guide information may be output that guides only either one of a wall surface on which the clearest image can be projected and a wall surface on which the largest image can be projected. That is, rather than the guide information shown in (a) of FIG. 10 and the guide information shown in (b) of FIG. 10 being output sequentially, only either one of the guide information shown in (a) of FIG. 10 and the guide information shown in (b) of FIG. 10 may be output.

Meanwhile, when guide information is output in the step S906, the control unit 200 may detect whether either one of the wall surface regions selected in the step S904 has been selected by the user (S908). As an example, the control unit 200 may determine whether either one wall surface region has been selected based on the user's response to the guide information output for each wall surface region selected in the step S906. Furthermore, when either one wall surface region is selected based on the user's response, the control unit 200 may determine the selected region as a region where the image is to be projected (S910).

Then, the control unit 200 may proceed to step S306 of FIG. 3 to control the rotation drive unit 283 to swivel the base rotation portion 31 so as to face the determined image projection region. Furthermore, the head driving unit 281 and height adjustment unit 282 may be controlled to face a location of the image projection region designated at a designated height.

Meanwhile, when an obstacle is detected in a region where an image is to be projected, the image projection device 1 according to an embodiment of the present disclosure may project the image by avoiding the obstacle or reduce a size of the projected image, thereby preventing the projected image from being covered by the obstacle.

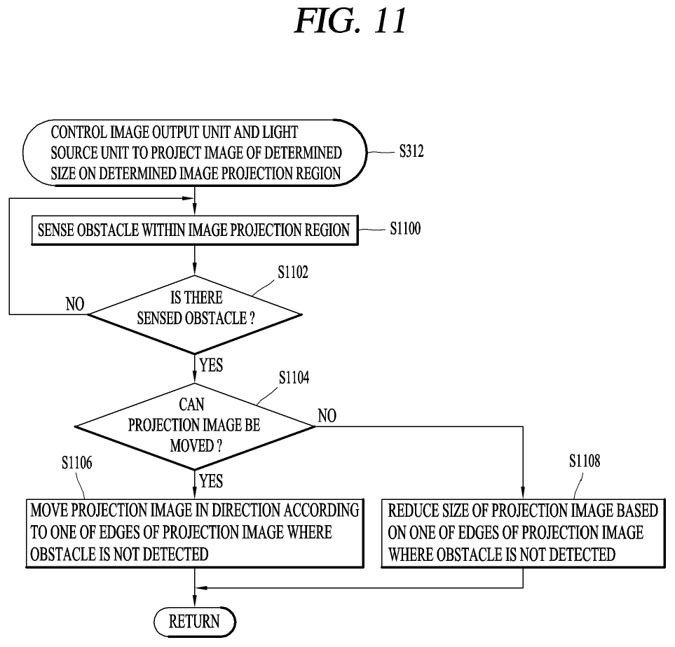

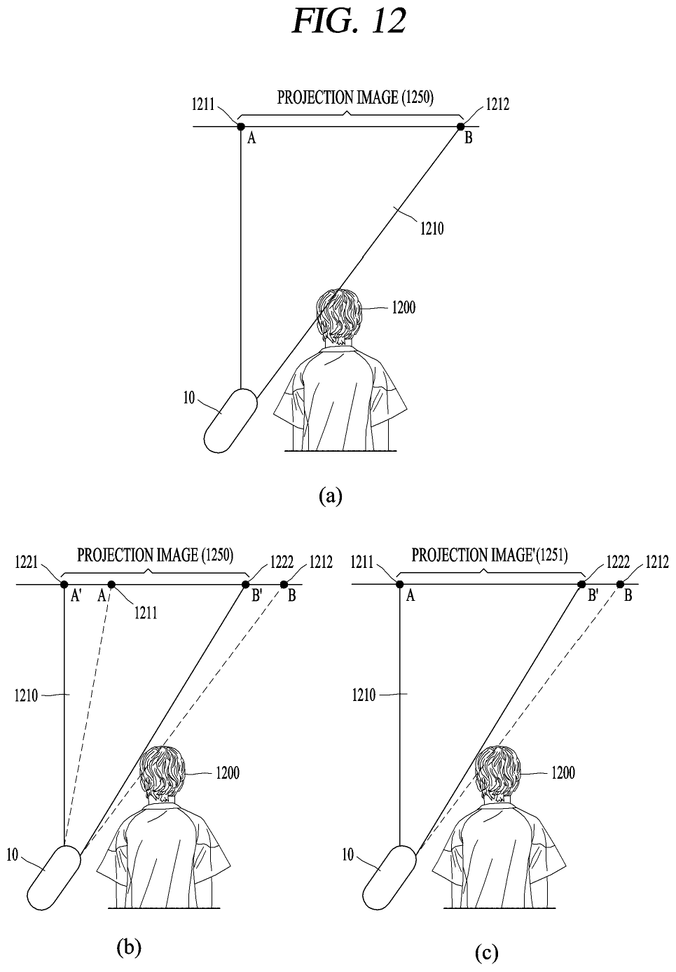

FIG. 11 is a flowchart showing an operation process of detecting, by the image projection device 1, an obstacle within an image projection region and projecting an image while avoiding the detected obstacle. Furthermore, FIG. 12 is an exemplary diagram showing an example of projecting, by the image projection device 1, an image while avoiding the obstacle or reducing a size of the projected image.

First, referring to FIG. 11 and (a) of FIG. 12, the control unit 200 of the image projection device 1 may proceed to the step S312 of FIG. 3, to sense, when an image is projected in an image projection region determined based on information sensed around the image projection device 1 and in a size determined based on an illuminance of the image projection region, an obstacle blocking the projected image within a region where the image is projected. For example, the control unit 200 may sense an obstacle located around an edge of a region where the image is to be projected based on an image of the image projection region acquired from the distance sensor 233 such as a laser sensor or a TOF sensor, or the camera 221.

Furthermore, the control unit 200 may determine whether there is an obstacle based on a result of the sensing in the step S1100 (S1102). For example, the control unit 200 may determine, when a state in which an obstacle is sensed in the step S1102 lasts longer than a preset period of time, that the obstacle has been detected. Therefore, if the state in which an obstacle is sensed does not last longer than the preset period of time, the control unit 200 may determine that the obstacle is not detected.

Meanwhile, as shown in (a) of FIG. 12, when a portion of the user's head 1200 enters a light irradiation space 1210, a space where light from the output unit 250 is irradiated to a region corresponding to a projection image 1250, the control unit 200 may sense a portion of the user's head 1200 that has entered the light irradiation space 1210 as an obstacle in the step S1100.

Furthermore, when it is determined that an obstacle has been detected as a result of the obstacle detection determination in the step S1102, the control unit 200 may determine whether a location of the projection image 1250 can be moved (S1104).

For example, the control unit 200 may determine that the location of the projection image 1250 can be moved when there is a sufficient region where the image can be projected around the projection image 1250 of the image projection region, that is, a wall surface on which the image is projected. In this case, whether there is a sufficient region around the projection image 1250 where an image can be projected may be determined depending on whether there is no region covered by an obstacle around the projection image 1250, or whether there is a region around the projection image 1250 whose surface curvature is below a preset level, and whether a size of the region whose surface curvature is below a preset level is above a preset size.

More specifically, the control unit 200 may detect whether there is a sufficient region where an image can be projected around the remaining edges of the projection image 1250 other than the edge where the obstacle is currently detected, in order to determine whether the location of the projection image 1250 can be moved. Furthermore, when there is a sufficient region where an image can be projected around at least one of the remaining edges, it may be determined that the projection image 1250 can be moved.

As a result of the determination in the step S1104, when it is determined that the location of the projection image 1250 can be moved, the control unit 200 may move a location where the projection image 1251 is projected within the image projection region (S1106). In this case, the control unit 200 may move the image projection region in a direction according to one of the edges of the projection image 1250 in which no obstacle is detected.

That is, as shown in (b) of FIG. 12, when a portion of the user's head 1200 enters the right side of the light irradiation space 1210, the control unit 200 may determine that an obstacle has been detected at a right edge 1212 of the projection image 1250. Therefore, it may be determined that the projection image 1250 can be moved by detecting whether there is a region where an image can be projected around the remaining edges of the projection image 1250 other than the right edge 1212.

Meanwhile, when there is a sufficient region on a left edge 1211 of the projection image 1250 where the image can be projected, the control unit 200 may move the projection image 1250 in a direction corresponding to the left edge 1211. As an example, the control unit 200 may control the rotation drive unit 283 to allow the base rotation portion 31 so as to swivel counterclockwise by a predetermined angle.

Then, as shown in (b) of FIG. 12, the projection image 1250 may move by a predetermined distance to the left. Accordingly, the left edge and the right edge may each move by a predetermined distance. Therefore, the left edge moves from a first location 1211 to a second location 1221, and the right edge also moves from a first location 1212 to a second location 1222, so that the light irradiation space 1210 may move to the left. Therefore, the light irradiation space 1210 without an obstacle 1200 is formed through the movement of the projection image 1250, and accordingly, an image 1250 that is not covered by the obstacle 1200 may be projected.

On the contrary, when there is no sufficient region where the image can be projected around at least one of the remaining edges other than the edge where the obstacle is currently detected, the control unit 200 may determine that the projection image 1250 cannot be moved. Then, the control unit 200 may reduce a size of the projection image 1250 based on one of the edges of the projection image 1250 in which no obstacle is detected (S1108).

Then, as shown in (c) of FIG. 12, the size of the projection image 1250 may be reduced based on the edge where no obstacle is detected, that is, the left edge 1211. Accordingly, as the size of the projection image 1250 is reduced, a horizontal axis length of the projection image 1250 is reduced, and the right edge 1212 of the projection image 1250 may move toward the left edge 1211, that is, may move from the first location 1212 to the second location 1222. Accordingly, the light irradiation space 1210 without the obstacle 1200 is formed by reducing the projection image 1250, and accordingly, the image 1250 that is not covered by the obstacle 1200 may be projected.

Meanwhile, when an image that is not covered by the obstacle 1200 is projected by moving or reducing the projection image 1250 in this manner, the control unit 200 may proceed to step S314 of FIG. 3 to determine whether the image projection has ended.

Furthermore, when the image projection is not ended, the process may proceed to step S312 of FIG. 3 again to maintain a state of projecting the image on the image projection region. In this case, the control unit 200 may detect an obstacle again according to the operation process shown in FIG. 11, and control the drive unit 280 (move the projection image 1250) or control the output unit 250 (reduce the size of the projected image 1250) so as to project the image by avoiding the detected obstacle.

Meanwhile, in the foregoing description, although an example has been described in which a size of the projection image is determined based on an illuminance of the detected image projection region or an area of the region where the image can be projected, a size of the image to be projected may also of course be automatically determined based on a distance between the determined image projection region and the user.

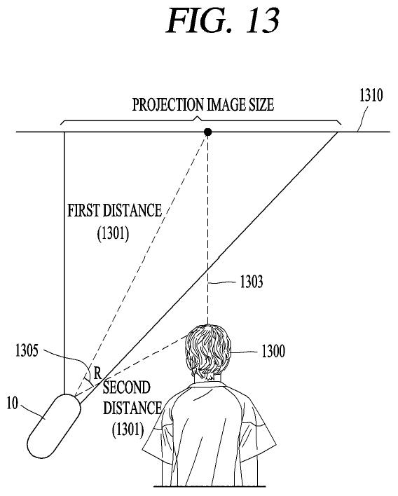

FIG. 13 is an exemplary diagram showing an example of determining, by the image projection device 1 according to an embodiment of the present disclosure, a size of a projected image according to a distance between the image projection region and the user.

First, when the front portion of the head 10 of the image projection device 1, that is, the output unit 250 from which light is irradiated, faces a specific wall surface 1310 set as an image projection region, the control unit 200 of the image projection device 1 may calculate a distance (first distance) 1301 from the output unit 250 to the specific wall surface 1310 set as the image projection region. Furthermore, the control unit 200 may calculate a distance (second distance) 1302 from the output unit 250 to the user's head 1300 looking at the image projection region based on an image acquired from the camera 221 or a result of sensing by the distance sensor 233. Furthermore, the control unit 200 may calculate an interval angle (R) 1305 between a first virtual line segment from the output unit 250 to the specific wall surface 1310 and a second virtual line segment from the output unit 250 to the user's head 1300.

When the first distance 1301, the second distance 1302, and the interval angle (R) 1305 are calculated, the control unit 200 may calculate a distance (third distance) 1303 from the user's head 1300 to the specific wall surface 1310 using a triangulation method. Furthermore, once the third distance 1303 is calculated, a size of the image to be projected may be determined based on the calculated third distance 1303. In this case, the larger the third distance 1303, the larger the size of the image may be.

Meanwhile, a size of the projection image determined according to the third distance 1303 from the user's head 1300 to the specific wall surface 1310 may be determined within a maximum image size limit allowed according to an illuminance detected from the specific wall surface 1310. Therefore, when the illuminance detected from the specific wall surface 1310 is high, the size of the projection image may be limited even when the third distance 1303 is large. On the contrary, even when the illuminance detected from the specific wall surface 1310 is low, the size of the projection image may be determined to be small when the third distance 1303 is small.

In this case, when the size of the projection image is small even when the ambient illuminance is low, the projection image may become excessively bright depending on the light concentration. Accordingly, when the ambient illuminance is lower than a predetermined level compared to the determined size of the projection image, the control unit 200 may lower the light output of the light source unit 252 to prevent an excessively bright image from being output.

Meanwhile, the foregoing description has described a case where the image projection device 1 according to an embodiment of the present disclosure is used as a projector that projects an image. However, the image projection device 1 may also be used as an illumination device that projects preset illumination light at the user's request or when not projecting a designated image. That is, the image projection device 1 may operate as an illumination device when it is in an idle state with no requested or performed operation.

When operating as an illumination device in this manner, the control unit 200 may output light from the light source unit 252 as the illumination light through the output unit 250. Alternatively, the control unit 200 may control the image output unit 251 to generate a preset illumination image through the light of the light source unit 252, thereby causing illumination light including the preset illumination image to be output through the output unit 250.

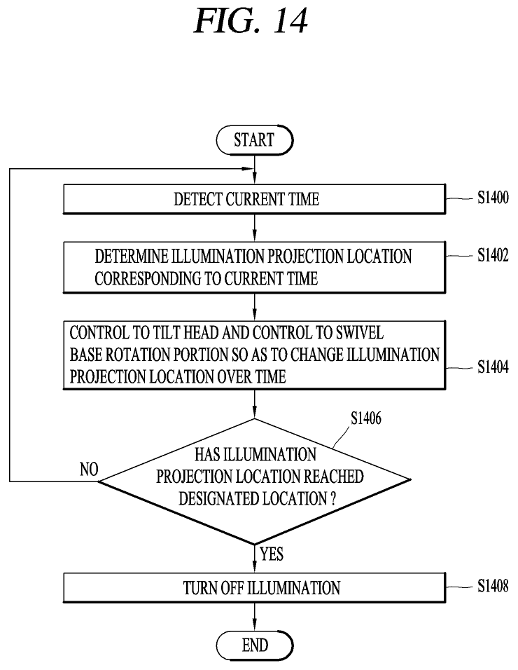

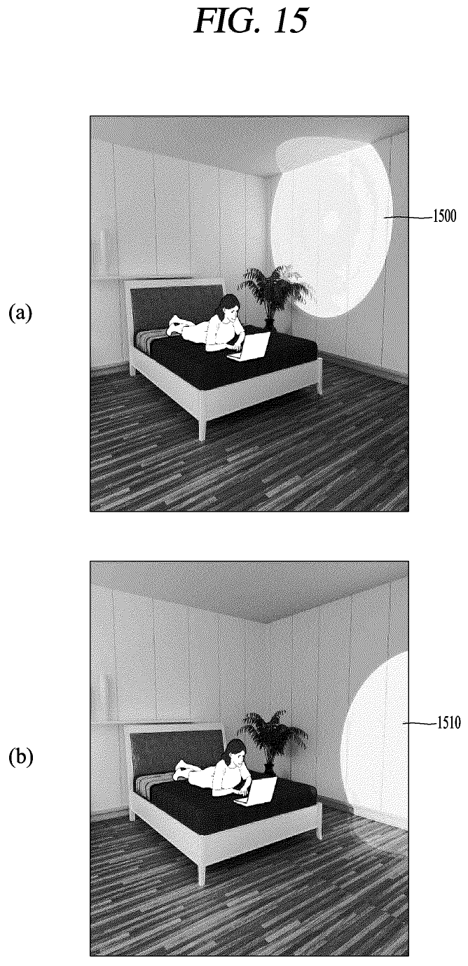

In addition, when operating as an illumination device in this manner, the control unit 200 may control the drive unit 280 and the output unit 250 so as to vary a location at which the illumination light is projected by reflecting the passage of time. Hereinafter, referring to FIGS. 14 to 16, an operation process of operating, by the image projection device 1 according to an embodiment of the present disclosure, as the illumination device, and examples thereof will be described.

First, FIG. 14 is a flowchart showing an operation process of operating, by the image projection device 1 according to an embodiment of the present disclosure, as an illumination in which a location at which light is projected varies depending on a time of detection.

Referring to FIG. 14, the control unit 200 of the image projection device 1 may detect a current time (S1400). For example, the control unit 200 may detect a current time through a built-in digital clock or an external server providing time information.

Then, the control unit 200 may determine a location where illumination light is projected based on the detected current time (S1402). Furthermore, the base rotation portion 31 may be swiveled by controlling the rotation drive unit 283 to gradually change the location where the illumination light is projected over time. Furthermore, the head drive unit 281 and the height adjustment unit 282 may be controlled to change the location where the illumination light is projected (S1404). Therefore, as shown in (a) of FIG. 14, the illumination light projected to a first location 1500 may be projected to a second location 1510 shown in (b) of FIG. 14 over time.

For example, when operating as an illumination device, the control unit 200 may determine an initial projection location of the illumination light based on the detected current time. In this case, the control unit 200 may determine the initial projection location of the illumination light based on a location of the sun or moon corresponding to the current time.

Accordingly, when the currently detected time is morning or early evening, the control unit 200 may control a tilt angle of a front portion of the head 10, that is, the output unit 250, to project the illumination light in a direction close to horizontal, by reflecting a low solar altitude or low lunar altitude. Additionally, the base rotation portion 31 may be swiveled to face the east, for example, the left of the image projection device 1 depending on a location of the sun or moon.

In this state, the control unit 200 may change a location where the illumination light is projected over time. In this case, the control unit 200 may control the drive unit 280 to change the location where the illumination light is projected based on a movement of the sun or moon over time.

Therefore, over time, the location where the illumination light is projected may move clockwise. Furthermore, an altitude at which the illumination light is projected may also change depending on a location of the sun and moon over time. That is, the altitude at which the illumination light is projected may gradually increase until the current time reaches noon or midnight, and the altitude at which the illumination light is projected may be the highest at noon or midnight. Furthermore, after noon or midnight, the altitude at which the illumination light is projected may be lowered again.

Meanwhile, the illumination light may of course gradually vary in size and brightness over time. For example, as the projection altitude of the illumination light is lowered, the control unit 200 may control the output unit 250 to reduce a size of the illumination light or output the illumination light having a low brightness. On the contrary, as the projection altitude of the illumination light increases, the output unit 250 may be controlled to increase a size of the illumination light or output the illumination light having a high brightness.

In this manner, a change in the projection location of the illumination light over time may continue until the projection location of the illumination light reaches a designated location (S1406). In this case, since the projection location of the illumination light changes over time, the step S1406 may also be understood as changing the projection location of the illumination light until a designated time is reached.

For example, when the projection location of the illumination light reaches a horizontal limit point upon reaching a designated sunset time or moonset time, the control unit 200 may determine that the projection location of the illumination light has reached the designated location. Alternatively, upon reaching a location corresponding to a time (e.g., 2:00 a.m.) previously set by the user, it may be determined that the projection location of the illumination light has reached the designated location (i.e., when it becomes 2:00 a. m.). Then, the control unit 200 may turn off the light source unit 252 to end the projection of the illumination light (S1408). That is, the projection of the illumination light may be automatically stopped when a time designated by the user has reached.

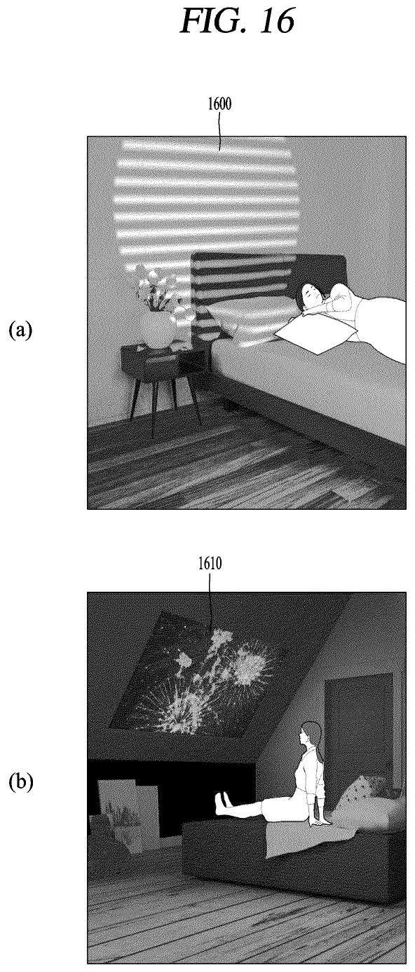

Alternatively, when the illumination light reaches a designated location, that is, reaches a designated time, the control unit 200 may control the image output unit 251 and the light source unit 252 to output preset illumination light requested by the user. For example, when a designated sunset time is reached, the control unit 200 may project preset illumination light 1600 for creating a sunset to a designated projection location as shown in (a) of FIG. 16. Alternatively, when a designated wake-up time is reached, preset illumination 1610 for creating fireworks may be projected to a designated projection location as shown in (b) of FIG. 16. Additionally, the control unit 200 may output an acoustic signal linked to the preset illumination through the acoustic output unit 253.

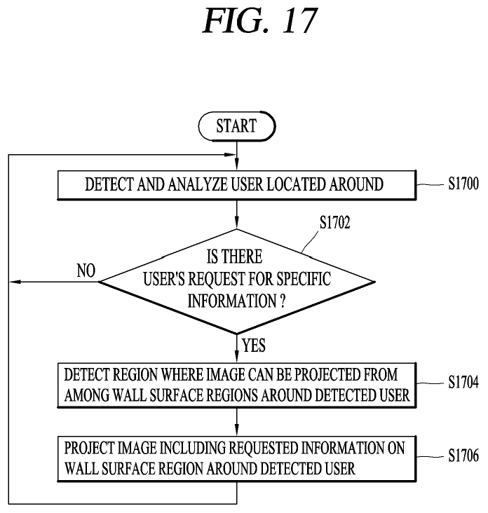

Meanwhile, the image projection device 1 according to an embodiment of the present disclosure may analyze, when operating as an illumination device, the user's context based on information sensed around the image projection device 1 and project light including information requested by the user around the user according to the analyzed user's context. That is, the image projection device 1 may also perform a function as an artificial intelligence assistant that performs a function according to the user's action or request. FIGS. 17 to 19 are diagrams for explaining an operation process and operation examples of the image projection device 1 in such cases.

First, FIG. 17 is a flowchart showing an operation process of providing, by the image projection device 1, appropriate information based on the user's context detected around the image projection device 1.

Referring to FIG. 17, the image projection device 1 according to an embodiment of the present disclosure may detect a user and analyze the user based on information items sensed therearound (S1700). Here, the sensed information may be an image acquired through the camera 221 or may be the user's voice information sensed through a microphone. Alternatively, the sensed information may include information on peripheral devices that can be connected to the image projection device 1.

Furthermore, the control unit 200 may analyze the user's location and the user's action based on the sensed information. For example, the control unit 200 may analyze the user's location based on an image acquired from the camera 221. Alternatively, the user's location may be detected based on a speaker's location detected as a result of voice recognition. Additionally, the control unit 200 may detect a peripheral device being operated by the user based on at least one peripheral device operating around the image projection device 1. That is, the user's action that operates the peripheral device may be detected.

In this state, the control unit 200 may sense whether there is the user's request for specific information (S1702). For example, when the user requests specific information by his or her voice, the control unit 200 may sense that the user has requested specific information in the step S1702. Alternatively, when the user makes a specific gesture while operating the peripheral device, it may be sensed that the user is requesting specific information related to the peripheral device.

As a result of the sensing in the step S1702, when it is determined that the user requests specific information, the control unit 200 may detect a region where an image can be projected from among wall surfaces around the detected user location (S1704). Furthermore, when a region where an image can be projected is detected, light including specific information requested in the step S1702 may be projected on the sensed region, that is, a wall surface around the user.

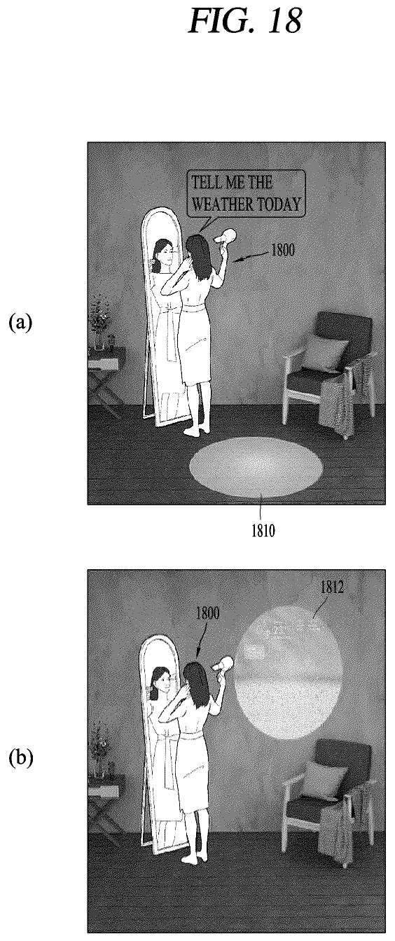

Therefore, as shown in (a) of FIG. 18, when a user 1800 requests today's weather by his or her voice from the image projection device 1 that projects illumination light 1810, the control unit 200 may acquire weather information corresponding to today's weather from a preset server (e.g., a weather information providing server) according to the request of the user 1800. Furthermore, based on a result of recognizing a speaker or image information acquired from the camera 221, a location of the user 1800 may be detected, and a region where an image can be projected may be detected from an indoor wall surface around the detected location of the user 1800.

Furthermore, upon detecting the region where the image can be projected, as shown in (b) of FIG. 18, image information 1812 including today's weather information may be projected on the detected region around the user 1800 where the image can be projected. Therefore, the user 1800 may check today's weather information requested by himself or herself through the image information projected therearound.

Meanwhile, the control unit 200 of the image projection device 1 according to an embodiment of the present disclosure may of course infer information required by the user based on a result of analyzing the user's action as well as when the user directly requests specific information by his or her voice, and project light including the inferred information on a wall surface around the user.

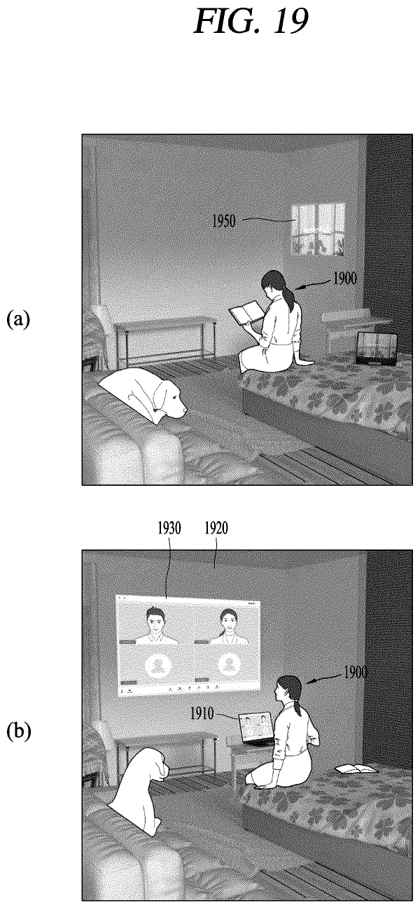

For example, the control unit 200 may analyze the user's action from the user's image acquired through the camera 221. In this case, as shown in (a) of FIG. 19, when the user is reading, a background image 1950 corresponding to the analyzed user's action, that is, reading action, may be projected on the detected region around the user where the image can be projected. In this case, the control unit 200 may output preset background music according to the background image 1950 through the acoustic output unit 253.

On the contrary, when the user operates at least one peripheral device, the image projection device 1 may perform a communication electronic device driven around the image projection device 1, according to the user's designated gesture. Furthermore, an image including information provided from the connected electronic device may be projected on the detected region around the user where the image can be projected.

Accordingly, as shown in (b) of FIG. 19, when a user 1900 operates a laptop 1910, the control unit 200 may sense a gesture of the user 1900 or a request of the user 1900 through the laptop 1910, such as covering the image projection device 1. Furthermore, in response to the sensed request, a communication connection may be established with the laptop 1910 being operated by the user 1900 to receive image information on which the user is working from the laptop 1910. Here, the image information being worked on may be image information displayed on a display of the laptop 1910 being operated by the user 1900.

Furthermore, the image projection device 1 may detect a wall surface 1920 on which an image can be projected around the user. Furthermore, upon detecting the wall surface 1920 where the image can be projected, image information 1930 received from the laptop 1910 may be projected on the detected wall surface 1920. Accordingly, the same image displayed on a device being operated by the user may be projected as an image on a wide screen through the image projection device 1. In this case, image information projected through the image projection device 1 and information displayed on a screen of a peripheral device, that is, the laptop 1910, connected to the image projection device 1 may be synchronized with each other.

The foregoing present disclosure may be implemented as computer-readable codes on a program-recorded medium. The computer-readable computer-medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and also include a device implemented in the form of a carrier wave (for example, transmission via the Internet). In addition, the computer may include the control unit 200 of the image projection device 1 according to an embodiment of the present disclosure.

Therefore, the detailed description should not be limitedly construed in all of the aspects, and should be understood to be illustrative. The scope of the present disclosure should be determined by reasonable interpretation of the appended claims and all changes that come within the equivalent scope of the present disclosure are included in the scope of the present disclosure.

1. An image projection device, the device comprising:
a head having an image output unit that outputs image information and a light source unit that emits light;
a support whose one end is formed to connect to the head, and support the head; and
a main body unit connected to the other end of the support, formed to support the support and the head connected to the support, and formed to be horizontally rotatable around a central axis,
wherein a head body forming a housing of the head is formed with a head fastening groove on a side surface thereof so as to be coupled to a first protruding portion protruding from one point on the side surface at one end of the support, and the first protruding portion is coupled to the head fastening groove, and the head is formed to be rotatable up and down with respect to the support around the head fastening groove connected to the first protruding portion.

2. The device of claim 1, further comprising:
at least one satellite speaker formed to be detachable from the main body unit,
wherein an upper end portion of a body of the main body unit forming a housing of the main body unit comprises a storage region in which the at least one satellite speaker can be stored.

3. The device of claim 2, wherein the storage region comprises a charging pad capable of charging at least one satellite speaker stored in the storage region.

4. The device of claim 1, wherein the body of the main body unit forming the housing of the main body unit is formed with a support fastening groove extending along an up-down direction of the body of the main body unit on a side surface thereof, and a second protruding portion protruding from one point on the side surface at the other end of the support is coupled to the support fastening groove, and the support connected to the head along the support fastening groove is formed to be movable along an up-down direction of the body of the main body unit.

5. The device of claim 4, wherein an inner side of the head body comprises at least one motor or actuator connected to a first protruding portion at one end of the support coupled through the head fastening groove to provide power for rotating the head up and down, and
wherein an inner side of the body of the main body unit comprises at least one motor or actuator connected to a second protruding portion at the other end of the support coupled through the support fastening groove to provide power for moving the support up and down.

6. The device of claim 1, wherein the main body unit further comprises:
a main body support portion that supports the main body unit to maintain the center of gravity of the image projection device during the rotation of the main body unit and an up-down rotation of the head.

7. The device of claim 1, wherein a microphone for collecting an acoustic signal around the image projection device is formed at one end of the support.

8. An image projection device, the device comprising:
an input unit including a camera that acquires ambient image information and a microphone that collects an ambient acoustic signal including a user's voice;
a sensing unit including an illumination sensor that detects an ambient illuminance;
an output unit including an image output unit that outputs the image information and a light source unit that emits light;
a drive unit that can change horizontal and vertical directions faced by the output unit and a height of the output unit; and
a control unit that determines whether an image projection request is made based on information items sensed through the input unit, controls, when a specific indoor region is designated as an image projection region from a user according to a result of the determination, the drive unit to allow the output unit to face the designated image projection region, detects, when the output unit faces the image projection region, an illuminance of the image projection region, determines a size of an image to be projected according to the detected illuminance, and controls the output unit to project an image according to the determined image size.

9. The device of claim 8, further comprising:
a plurality of satellite speakers formed to be separable from the image projection device,
wherein the control unit sets a specific indoor region as the image projection region according to a location where the satellite speakers are disposed, and controls the drive unit so as to allow the output unit to face the set image projection region.

10. The device of claim 9, wherein the control unit determines a size of the image to be projected based on a separation distance between the disposed satellite speakers.

11. The device of claim 9, wherein the control unit calculates a distance between a plurality of satellite speakers, and sets, when the calculated distance is above a preset minimum distance, a specific indoor region as the image projection region according to a location where the plurality of satellite speakers are disposed.

12. The device of claim 8, wherein the control unit finds a region where an image can be projected from among respective indoor regions around the image projection device, selects regions satisfying different image conditions from each of at least one of the found regions, and controls the output unit and the drive unit to output guide information for recommending at least some of the regions selected according to the different image conditions to the user, and
wherein the different image conditions are conditions according to a size of the image or a brightness of the image.

13. The device of claim 8, wherein the control unit detects, when an obstacle is detected in a region where the image is projected, whether a location of the projected image can be moved, and controls the drive unit to change a direction faced by the output unit, or controls the output unit to change a size of the projected image depending on whether the location of the projected image can be moved.

14. The device of claim 13, wherein the control unit determines whether a location of the projected image can be moved depending on whether there is a region around an indoor region in a region where the image is projected with a surface curvature below a preset level, and whether a size of the region with the surface curvature below the preset level is above a preset size.

15. The device of claim 8, wherein the control unit calculates, when the output unit faces the image projection region according to the control of the drive unit, a first distance between the center of the image projection region and the output unit, calculates a second distance between the output unit and the user from the user's location detected based on information items sensed through the input unit, calculates an interval angle between a first virtual line segment connecting the center of the image projection region and the output unit and a second virtual line segment connecting the output unit and the user, calculates a third distance between the center of the image projection region and the user based on the first distance, the second distance, and the interval angle, and determines a size of an image to be projected on the image projection region based on the calculated third distance.

16. The device of claim 8, wherein the control unit operates, as a result of determining whether an image projection request is made based on information items sensed through the input unit, when the projection of the image is not requested, in an illumination mode to control the drive unit so as to allow the output unit to face a previously designated illumination light projection location, and to control the output unit so as to project light from the light source unit to the illumination light projection location.

17. The device of claim 16, wherein the control unit changes the illumination light projection location over time.

18. The device of claim 16, wherein the control unit detects, when operating in the illumination mode, the user's location based on at least one of image information sensed through the input unit and the location of a speaker recognized from the acoustic signal, and projects an image including information according to the user's request sensed through the input unit around the detected user's location.

19. The device of claim 18, further comprising:
at least one peripheral device,
wherein the control unit receives, when operating in the illumination mode, image information from at least one peripheral device that is in communication connection with the image projection device, and projects the image information received from the peripheral device around the location of the detected user.

20. The device of claim 19, wherein the control unit projects image information synchronized with screen information displayed on a display of the at least one peripheral device around the user's location.
